(19) United States
(12) Patent Application Publication
(10) Pub. No.: US 2026/0340402 A1
(43) Pub. Date: Oct. 29, 2026

(54) SYSTEMS AND METHODS FOR NARRATIVE GENERATION FROM EMBEDDINGS

(71) Applicant: Royal Bank of Canada, Toronto (CA)

(72) Inventors: Leo Feng, Toronto (CA); Ruizhi Deng, Coquitlam (CA); He Zhao, Richmond (CA); Mohamed Osama Ahmed, Vancouver (CA); Frederick Tung, North Vancouver (CA)

(21) Appl. No.: 19/658,100

(22) Filed: Apr. 24, 2026

Related U.S. Application Data
(60) Provisional application No. 63/794,174, filed on Apr. 24, 2025.

(51) Int. Cl. G06N 3/0895; G06N 3/044

(52) U.S. Cl. CPC G06N 3/0895; G06N 3/044

(57) ABSTRACT

Systems and methods for narrative generation. Data representations in a first data domain are received. Each set of data representations of the first data domain is transformed into multiple sets of data representations of a second data domain by an adapter. Narratives corresponding to the data representations can be generated using a large language model by interpreting the sets of data representations of the second data domain generated by the adapter. The adapter can be a plurality of multi-layer perceptrons or a recurrent neural network. The LLM is frozen during training.

### CROSS-REFERENCE TO RELATED APPLICATIONS

This application claims priority to and benefit from U.S. Provisional Patent Application No. 63/794,174, filed on Apr. 24, 2025 and entitled “SYSTEMS AND METHODS FOR NARRATIVE GENERATION FROM EMBEDDINGS”, the entirety of which is hereby incorporated by reference herein.

### TECHNICAL FIELD

The present disclosure relates to the generation of narratives from embeddings and, in particular, to the generation of narratives by interpreting embeddings comprising data representations of events using one or more machine learning models.

### BACKGROUND

In many modern applications, understanding and predicting the behavior of clients (which may refer to individual users, businesses, or user accounts) is crucial for delivering personalized services, optimizing marketing efforts, and providing tailored recommendations. Various systems have been proposed to analyze and model client data, such as demographic details, transactional history, browsing patterns, and social interactions.

Traditionally, client representations were built using explicit features such as age, gender, location, and purchase history. These representations were manually crafted, often requiring significant domain expertise to select and define the most relevant attributes. While such systems provided basic insights, they lacked the ability to capture complex patterns and relationships in the data, limiting their effectiveness in predictive modeling or personalization.

Further, interpreting these client representations, for example to generate narratives, requires significant knowledge and expertise both in client behavior and in the field to which the client representations pertain. Moreover, for a holistic understanding of the client representations, an enormous volume of data may be required to be analyzed or processed. As such, client representation interpretation can be costly, inefficient, and challenging.

Accordingly, systems and methods that enable the generation of narratives from client representations remain highly desirable.

### SUMMARY

In accordance with an aspect of the present disclosure, a narrative generation method is disclosed, comprising: receiving a first set of data representations of a first data domain; generating a plurality of second sets of data representations of a second data domain from the first set of data representations using an adapter; and generating one or more narratives from the plurality of second sets of data representations by interpreting the plurality of second sets of data representations using a large language model (LLM).

In some aspects, the first set of data representations comprises vector embeddings in the first data domain and the plurality of second sets of data representations comprises vector embeddings in the second data domain.

In some aspects, the vector embeddings in the first data domain correspond to a first vector dimension and the vector embeddings in the second data domain correspond to a second vector dimension different from the first vector dimension.

In some aspects, the adapter has been trained to map vectors from the first vector dimension to the second vector dimension.

In some aspects, the vector embeddings in the second data domain comprise language token embeddings.

In some aspects, the adapter comprises a plurality of independent multi-layer perceptrons (MLPs); each of the plurality of MLPs is configured to generate one of the plurality of second sets of data representations; and each of the plurality of second sets of data representations comprises a second set of data representations corresponding to an independent transformation of the first set of data representations by a respective MLP of the plurality of MLPs.

In some aspects, the plurality of independent MLPs are respectively initialized with different weights during training.

In some aspects, the adapter comprises a recurrent neural network (RNN); and each of the plurality of second sets of data representations comprises a second set of data representations corresponding to an independent transformation of the first set of data representations sequentially generated by the RNN.

In some aspects, the first set of data representations comprises sequential events.

In some aspects, the first set of data representations are generated by characterizing the sequential events using a neural network.

In some aspects, generating the one or more narratives using the LLM comprises: generating an input prompt for interpreting the plurality of second sets of data representations, the input prompt comprising the plurality of second sets of data representations; and processing the input prompt with the LLM.

In some aspects, the input prompt comprises: a first prompt for providing the LLM with background, context, or role for interpreting the plurality of second sets of data representations; and a second prompt defining the one or more narratives to be generated by the LLM.

In some aspects, the input prompt is generated according to a prompt template comprising placeholders for the plurality of second sets of data representations; and the input prompt defines one or more rules for the one or more narratives.

In some aspects, the adapter has been trained by: generating ground truth narratives from training sequential events using the LLM for evaluation against the one or more narratives generated using the LLM by interpreting the plurality of second sets of data representations.

In some aspects, each of the ground truth narratives comprises a sequence of tokens; the adapter has been trained by having the LLM generate tokens of the sequence of tokens in sequential order; and the adapter has been trained using a loss function comprising negative log-likelihood of the tokens.

In some aspects, the adapter has been trained by: identifying one or more ground truth data values from training sequential events for evaluation against one or more data values extracted from the plurality of second sets of data representations using the LLM.

In some aspects, the adapter comprises a plurality of jointly trained machine learning models.

In some aspects, the LLM is a pre-trained LLM; and the LLM was frozen during training of the adapter.

In some aspects, the first set of data representations comprises financial transactions; and the one or more narratives comprise: a financial recommendation based on the financial transactions, a description of the financial transactions, an analysis of the financial transactions, or combinations thereof.

In accordance with another aspect of the present disclosure, a method of training an adapter for use in narrative generation is disclosed, comprising: generating ground truth narratives from a plurality of sequential events using a pre-trained large language model (LLM); training the adapter to generate a plurality of second sets of data representations of a second data domain from a first set of data representations of a first data domain for interpretation by the pre-trained LLM by: generating a plurality of second sets of training data representations for each of a plurality of first sets of training data representations corresponding to the plurality of sequential events; generating a plurality of training narratives by interpreting the plurality of second sets of training data representations using the pre-trained LLM; and updating weights of the adapter based on a comparison of the plurality of training narratives against the ground truth narratives, the pre-trained LLM being frozen.

In accordance with another aspect of the present disclosure, a method of training an adapter for use in narrative generation is disclosed, comprising: identifying ground truth data values from a plurality of sequential events using a pre-trained large language model (LLM); training the adapter to generate a plurality of second sets of data representations of a second data domain from a first set of data representations of a first data domain for interpretation by the pre-trained LLM by: generating a plurality of second sets of training data representations for each of a plurality of first sets of training data representations corresponding to the plurality of sequential events; extracting a plurality of training data values by interpreting the plurality of second sets of training data representations using the pre-trained LLM; and updating weights of the adapter based on a comparison of the plurality of training data values against the ground truth values, the pre-trained LLM being frozen.

In some aspects, the adapter comprises a plurality of independent multi-layer perceptrons (MLPs); and the training of the adapter further comprises: initializing each of the plurality of independent MLPs with a distinct set of weights.

In accordance with another aspect of the present disclosure, a system is disclosed, comprising at least one processing unit configured to perform the method of any one of the above aspects.

In accordance with another aspect of the present disclosure, at least one non-transitory computer readable medium having stored thereon computer instructions is disclosed, which, when executed by at least one processor, causes the at least one processor to perform the method of any one of the above aspects.

### BRIEF DESCRIPTION OF THE DRAWINGS

Further features and advantages of the present disclosure will become apparent from the following detailed description, taken in combination with the appended drawings, in which:

FIGS. 1-2 depict a system for generating narratives from data representations, according to example embodiments.

FIG. 3 depicts a method of generating narratives from data representations using the system of FIGS. 1-2, according to an example embodiment.

FIGS. 4A-4C depict training of an adapter of the system of FIGS. 1-2, according to example embodiments.

FIGS. 5A and 5B depict methods of training the adapter of the system of FIGS. 1-2, according to example embodiments.

FIG. 6 depicts a method of generating embeddings from data representations, according to an example embodiment.

FIGS. 7A-7C depict example performance evaluations of the system of FIGS. 1-2.

It will be noted that throughout the appended drawings, like features are identified by like reference numerals.

### DETAILED DESCRIPTION

Recently, machine learning models have been employed to automatically generate client representations, for example, as data representations. Techniques such as collaborative filtering, matrix factorization, and neural networks can be utilized to create client embeddings, such as lower-dimensional vector representations that capture clients' behaviors and preferences in a way that is useful for various downstream applications. These embeddings can enable more accurate predictions, such as recommendations for products or services, but still face challenges related to scalability, interpretability, and adaptability. For narrative generation, large language models (LLMs) are typically used. However, client embeddings may not be inherently interpretable by LLMs, as they reside in a different feature space and were not encountered during the LLM's pre-training.

The interpretation of client representations and data representations in general, for example how to understand and extract meaningful insights from these high-dimensional vector representations, remains a significant challenge. Often, the data representations can be dense vector(s) that encode complex patterns but are difficult to interpret directly. As a result, there is a need for improved systems and methods for interpreting these representations in a manner that is understandable to both end-users and businesses.

In accordance with the present disclosure, systems and methods for interpreting client representations to generate narratives therefrom are provided. It should be noted that client representations are referenced herein as an example data representation that may be interpreted and that the present disclosure is also generally applicable for other types of data representations. Data representations may be a series of data that captures one or more events, actions, interactions, or items, for example, as a list or sequence. Data representations may exist in various forms, for example, as raw time-series data, raw tabular data, raw logs, and embeddings such as vectors. The data representations may be ordered or sorted, for example, according to data type, date of each event, action, etc., or an alphabetical ordering based on a data attribute, or may be unordered. In one example, data representations for an entity corresponding to a financial account may comprise time series data of a plurality of sequential financial transactions.

Generally, to perform data interpretation using an LLM on embeddings so as to generate narratives, an adapter can be used. In particular, data representations of a first data domain can be received. The data representations may be raw data or data representations that have been processed, for example, by a machine learning model such as a neural network, an autoencoder, an LLM, etc. The data representations of the first data domain can be processed by the adapter, which can transform or map the data representations from the first data domain to a second data domain. An LLM can process the transformed data representations to interpret or analyze the data representations so as to generate one or more narratives.

Narrative generation from embeddings interpretation can have many advantages. In particular, automated interpretation of a large volume of complex data to generate insightful narratives can be achieved. Accordingly, human resources in time and energy can be saved. Additionally, it is possible to provide insightful narratives even if the user does not have any experience or expertise in data analytics or the field pertaining to the data. For example, to generate narratives based on financial data such as a series of transactions, the user does not need to be knowledgeable in finance or accounting. Further, the present disclosure can overcome difficulties in data processing by machine learning models. For example, an LLM may be preferable for generating natural language narratives. However, the LLM may be trained to operate in a different data domain than the data representations that need to be interpreted. By utilizing an adapter, the data representations can be transformed into a data domain with which the LLM is familiar or trained to operate on.

More specifically, client representations (such as embeddings) can be versatile input features that can be generalized to diverse applications. Embeddings may be preferable for machine learning processing. In particular, as embeddings comprise condensed information extracted from raw data, they are more efficient to store and to process computationally. Embeddings are also generally more secure, as they are not easily interpreted when compared to natural language even when exposed or intercepted. However, client embeddings may be difficult to interpret directly, for example, by machine learning models such as LLMs, and may be treated as “black box” features. This opaqueness can be undesirable in high-stakes application areas such as credit adjudication in the field of finance, which often have enhanced explainability requirements from both internal stakeholders and external regulators. By leveraging an adapter and LLM to translate client embeddings into client narratives, explanations of client embeddings are made available in natural language, making them accessible to non-specialist audiences.

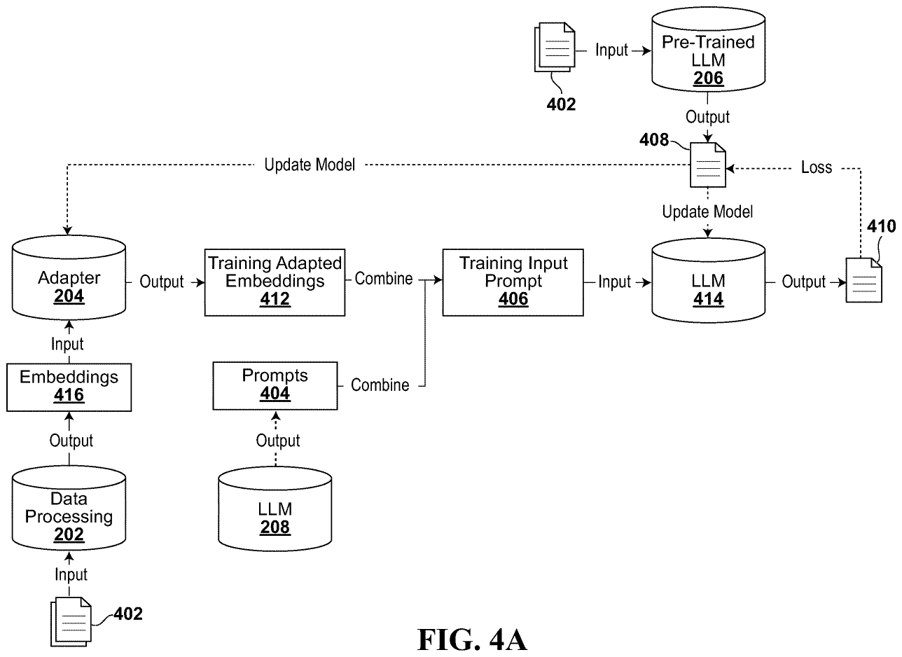

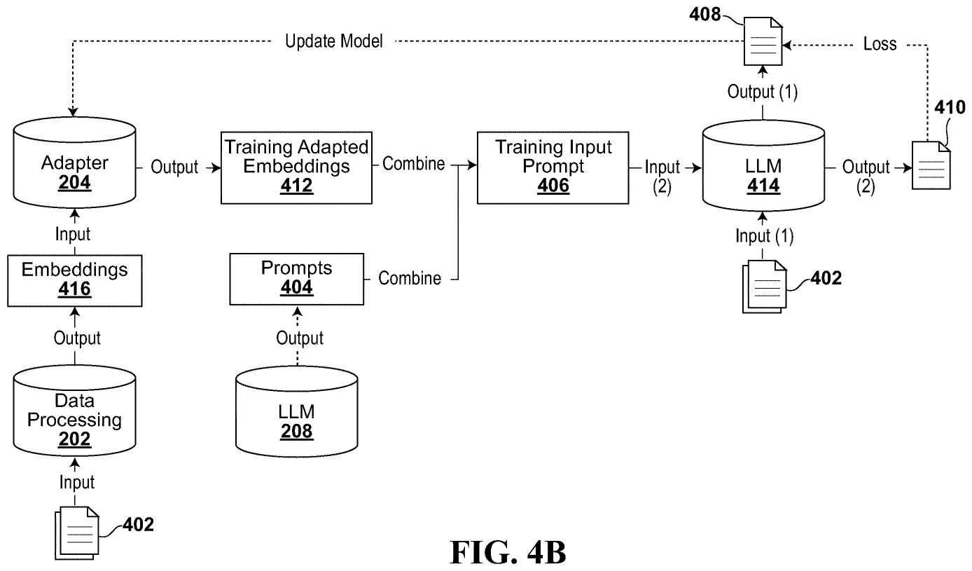

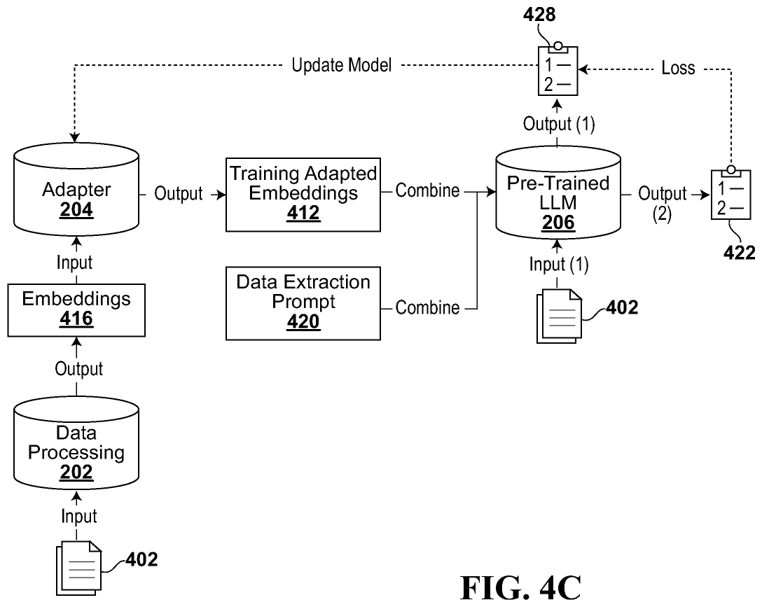

One method of generating narratives from embeddings is through the use of embedding language models (ELMs). ELMs can integrate embeddings directly into LLMs, transforming abstract vectors into human-understandable narratives tailored to specific contexts. This framework is useful in allowing LLMs to generalize to domains beyond their pre-training data, thus making them applicable to tasks involving structured or non-linguistic inputs (e.g., embeddings). An ELM generally comprises at least two components: (1) an adapter that projects raw embeddings (e.g., data representations of a first data domain) into the LLM's token embedding space as adapted embeddings (e.g., data representations of a second data domain); and (2) an LLM that processes (interprets) the adapted embeddings and instructions to generate the narratives. The ELM generally follows a two-stage training process: (1) adapter training, where an adapter is trained to process the raw embeddings and generate adapted embeddings; and (2) joint fine-tuning, where the LLM and adapter are fine-tuned together to incorporate the adapted embeddings. An overview of this training process is shown in FIG. 4A and described further herein.

To address the inability of the LLM to inherently interpret embeddings, an ELM introduces an adapter that projects these arbitrary embeddings into the same data domain (e.g., dimensional space) as language token embeddings that the LLM is trained to ingest. This adapter can be implemented as a Multi-Layer Perceptron (MLP) and is trained to transform the embeddings into a format that the LLM can understand (e.g., adapted embeddings). The adapted embeddings are then fed into the LLM alongside language instructions, enabling the LLM to generate the desired textual outputs (e.g., product descriptions or narratives).

One potential downside of the ELM is its reliance on the two-stage training process. That is, even if the LLM used for the ELM is pre-trained and does not need to be jointly trained with the adapter, the LLM may nevertheless be required to be jointly fine-tuned with the adapter. This is because the adapter alone may be unable to fully align the adapted embeddings with the LLM's feature space, and that joint fine-tuning can ensure that the LLM is able to effectively leverage and interpret the adapted embeddings to generate narratives.

This requirement of fine-tuning the LLM alongside the adapter can have several downsides. For example, fine-tuning of the LLM can lead to substantial loss in the LLM's original language capabilities (forgetting). As another example, deployment of the fine-tuned LLMs can require extensive model validation for bias and performance, and saving the modified LLM (often with billions of parameters) can incur high storage and computational costs. Further, the fine-tuning of the LLM itself can also require significant additional computational resources and power consumption.

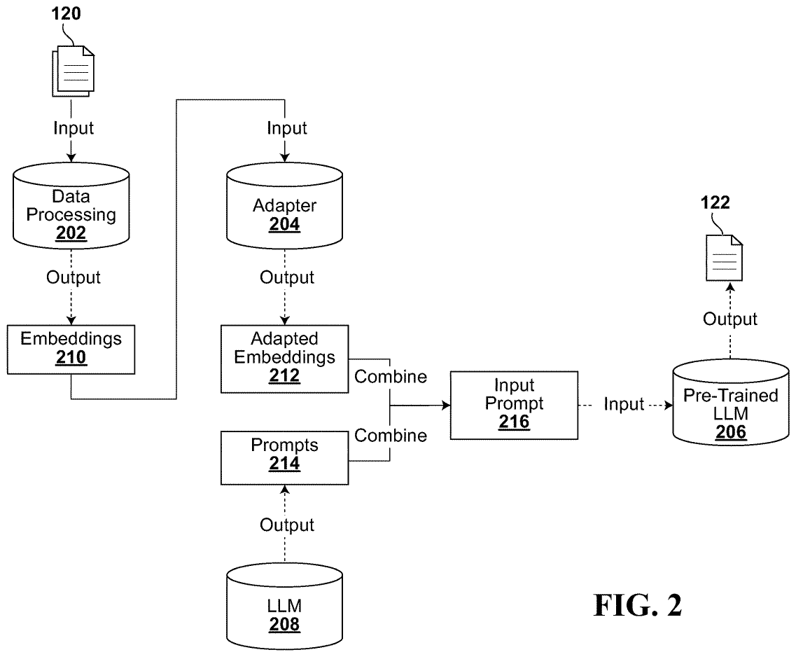

The present disclosure can address these issues via an improved framework for interpreting embeddings for narrative generation. The general framework of the present disclosure may be consistent with ELMs, as described further with respect to FIG. 2. That is, an adapter is used to generate adapted embeddings from raw embeddings, which are interpreted by the LLM. Beneficially, the present disclosure does not require the LLM to be jointly fine-tuned with the adapter, as is the case with ELMs. That is, the pre-trained LLM remains unmodified during training and may be used for embedding interpretations “as-is.” Accordingly, the LLM may be frozen during training (e.g., by not updating its weights) in order to preserve its original language capabilities and eliminate the need for additional validation. To address the inability of the pre-trained LLM in processing complex embeddings in a data domain it is not trained to operate in, the present disclosure introduces a modified adapter that can generate a plurality of sets of adapted embeddings (e.g., tokens) as compared to the single set of embeddings output from the adapter of the ELM. The plurality of sets of adapted embeddings may be conceptually similar and/or simpler, which, when ingested together by the LLM, can allow the LLM to adequately interpret the information contained within for the generation of the narratives.

The present disclosure can provide a number of advantages and technical benefits that represent specific improvements to the underlying computer technology. For example, by utilizing an unmodified LLM and freezing it during training (e.g., by not updating the LLM's weight parameters), the present disclosure can preserve the computational integrity and baseline performance characteristics of the LLM. Specifically, the frozen LLM architecture prevents gradients computed via backpropagation from updating the LLM's neural network layers, thereby addressing the risk of catastrophic forgetting, a technical phenomenon wherein fine-tuning causes degradation of the LLM's pre-trained knowledge representations and language processing capabilities stored in its weight matrices. The present disclosure can also achieve measurable improvements in computational efficiency during the training process. Because the adapter component typically comprises on the order of millions of trainable parameters while the LLM comprises billions of parameters (a difference of approximately three orders of magnitude), memory usage can be reduced during the updating of the model weights. Further, the deployment process can achieve concrete technical efficiencies in data storage and transmission. Specifically, to deploy the trained framework onto a computing platform or service, only the adapter's weight parameters need to be serialized, transmitted across network interfaces, and loaded into system memory, rather than the entirety of the LLM's parameter set. This reduction in deployment payload size can directly decrease storage I/O operations, network bandwidth consumption, and memory allocation overhead during model instantiation, making the disclosed systems and methods substantially more lightweight and scalable across distributed computing environments. Additionally, because the LLM remains unmodified throughout training and deployment, computing systems implementing the present disclosure can maintain direct API-level integration with local or remote (e.g., external cloud-based) inference services that host the pre-trained LLM, thereby eliminating the technical overhead associated with provisioning, validating, and operating a custom-modified LLM instance and instead leveraging existing computational infrastructure for the LLM's text generation operations.

It should be noted that, as used herein unless otherwise specified, a data domain may refer to a modality of data such as a data type or format, for example, image, text, audio, video, time series data, graph data; and/or may refer to a feature space of data, which can be a multi-dimensional space created by the features (e.g., variables or attributes) of the data representations. For example, each feature may be treated as a dimension in the feature space, and the data points or samples (e.g., each event, action, etc. in the data representation) can be represented as vectors in the feature space. As such, the feature space may be a mathematical representation of all possible combinations of the features in the data representations. As another example, a data domain may correspond to a particular feature space having a set of properties or parameters such as feature/attribute representation of the data representations, vector size or space, and dimensionality while another data domain may have a different feature space having a different set of properties or parameters.

As used herein, a “domain” is a grouping of one or more types of interactions having a defined common characteristic that is shared for all elements or data in the domain. One domain is distinct from another domain (“distinct domains”) if the two domains have a different common characteristic. A difference in common characteristics may be an inherent real difference that is recognized in defining the characteristic or difference, or may be an arbitrarily defined difference chosen by an implementer of the methods described herein according to the context and purpose.

Certain illustrative non-limiting examples follow. For example, where an entity is a hospital, there may be a single domain for “all arrivals,” or there may be distinct domains for each of ambulance arrivals, walk-in arrivals, and helicopter arrivals, where the common characteristic for each of the distinct domains is a particular method of arrival (e.g., ambulance, walk-in, and helicopter). Where an entity is an individual, there may be one distinct domain for bank account transactions and another distinct domain for credit card transactions, or there may be distinct domains for each of checking accounts and savings accounts (where the common characteristic for each of the domains is a particular account type), or for each credit card of a particular brand even if offered by the same bank. Where an entity is a monitored wildlife refuge, there may be one domain for all avians, or there may be distinct domains for different species of avians with each species being a common characteristic. Where an entity is a rideshare vehicle within a service that provides both transportation (e.g., of humans) and delivery services (e.g., food delivery), there may be a single domain for all trips, or there may be distinct domains for each of transportation trips and delivery trips, with the type of transported item being the common characteristic. The distinct domains may be mutually exclusive, but in some contexts they may overlap. For example, a hospital may have distinct domains for each of ambulance arrivals, walk-in arrivals, and helicopter arrivals and may have a further distinct domain for heart attack arrivals (which overlaps the other hospital domains and where the arrivals are for people with heart attacks, which is the common characteristic), but each is still a distinct domain. Or, where an entity is an individual, there may be distinct domains for each of credit card, mortgage, and line of credit (each being a common characteristic for a set of data), and then another distinct domain for credit products generally.

The term “data representation” is used herein to refer to data or representations thereof that describe, characterize, or correspond to a particular set of data, such as data associated with a particular entity. An entity may be an individual, an object, an item, an organization, a location, an event, etc., which can have data associated therewith. Data representations may be a series of data such as time series data that captures one or more events, actions, interactions, or items, for example, as a list or sequence, descriptive of an entity. Data representations may exist in various forms, for example, as time-series data, tabular data, logs, textual descriptions, lists, numerical data, and embeddings such as vectors. Embeddings derived from raw time series data are an example of data representations. The data representations may be ordered or sorted, for example, according to data type, date of each event, action, etc., or an alphabetical ordering based on a data attribute, or may be unordered. In some embodiments, data representations can comprise natural language text and descriptions. The text and descriptions may be sentences, paragraphs, bullet points, etc. Data representations can comprise both raw data and processed data. For example, for a set of data representations comprising raw data, embeddings generated from the raw data also comprise part of the data representations, as they also describe the entity, albeit in a different manner than the raw data itself.

As used herein, narratives may refer to insights or analysis that are derived or interpreted from data such as data representations that are presented in a coherent and human-readable manner and are relevant and logical in the context of the data representations. Narratives can highlight patterns, trends, or significant events and can make the data representations more accessible and meaningful, and easy to understand to a user, for example, one that is not familiar with the data representations or the field associated therewith. Narratives can transform large volumes of complex, raw data into a structured and understandable format such as natural language key points or sentences that provide context, insight, and actionable conclusions. In some embodiments, narratives may also comprise recommendations or suggestions formulated based on the data representations. In particular, narratives may be structured sentences, phrases, or paragraphs in natural language describing the insights or analysis and providing additional context and detail (e.g., “the client has had a steady stream of incoming deposits over a long period of time and is unlikely to default on loan payments”) as opposed to direct, simplified data (e.g., “low delinquency”).

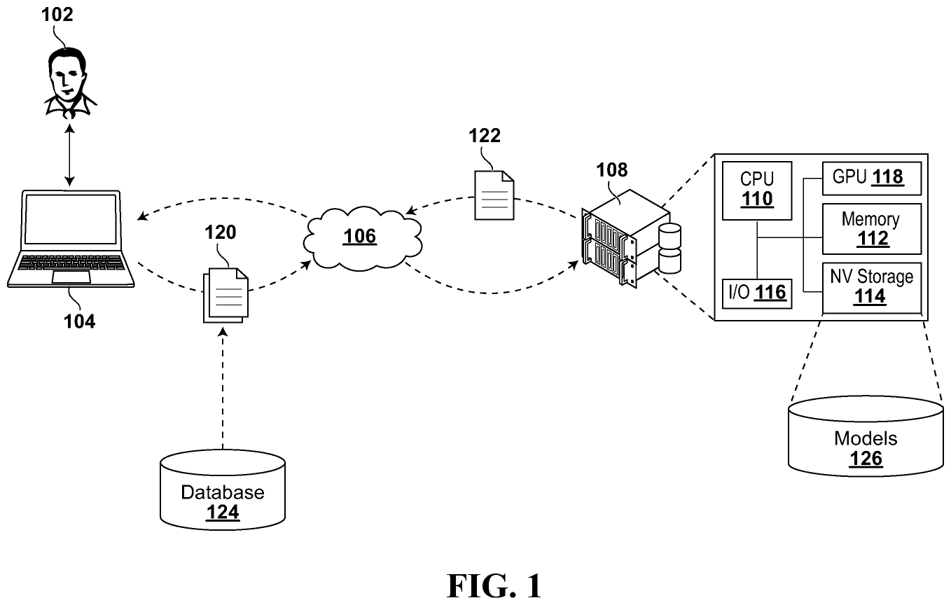

Embodiments are described below, by way of example only, with reference to FIGS. 1-7C.

FIG. 1 depicts a system for generating narratives from data representations, according to an example embodiment, shown in FIG. 1 as one or more servers 108. The implementation of the servers 108 is not restrictive and servers 108 may be an on-premises server, cloud-based server, or a hybrid thereof, for example. A user 102 may interact with the servers 108 via a device 104 over a communications network 106 (e.g., the internet). The device 104 may be a computer, as depicted in FIG. 1, but is not restricted to those devices expressly shown and may be any suitable device known in the art such as smart phones and tablets. The servers 108 may provide a graphical user interface (GUI) on the device 104 for ease of communication and operation control by the user. The implementation of the GUI is not restrictive and may be, for example, a mobile/computer application or a web page. The GUI can be used to provide input to and receive output from the servers 108. Additionally or alternatively, other user interfaces, such as an audio interface that allows receipt and processing of spoken commands, and that outputs spoken narratives, may be used.

The user 102 may be interested in generating narratives by interpreting the data representations using the servers 108. In particular, the user 102 may wish to interpret data representations 120 to determine narratives 122. The data representations 120 can be raw data or processed data, for example embeddings or data represented as vectors. The narratives 122 may be used to provide insights into the data representations 120 and can allow the user 102 to make informed decisions based on the data representations 120. In some embodiments, the data representations 120 can be financial data corresponding to sequential events such as a series of financial transactions or activities, for example associated with a particular entity. The narratives 122 may be insights or analysis of the financial transactions, for example descriptions thereof, patterns or key features thereof, inferences/conclusions based thereon, recommendations based thereon, or combinations thereof.

The servers 108 may be configured to interpret the data representations 120 to generate the narratives 122. In particular, the data representations 120 may be processed by one or more machine learning models 126 to generate the narratives 122, as described further herein. The machine learning models 126 may each be an artificial intelligence (AI) model or algorithm, a machine learning model or algorithm, and may comprise, in particular, an LLM and an adapter. The adapter may be a plurality of multi-layer perceptrons (MLPs) or a recurrent neural network (RNN). The data representations 120 may be transformed by the adapter prior to interpretation by the LLM to generate the narratives 122. The narratives 122 may be returned to the user 102 from the servers 108 to the device 104 for display, for example, over the communications network 106. In some embodiments, the narratives 122 may be further processed, for example, using an LLM, to generate emails, recommendations, insights, etc., based thereon.

According to the present disclosure, the data representations 120 may be provided to or retrieved by the servers 108, for example, from the device 104. The data representations 120 can also be retrieved from one or more external devices and/or one or more databases, such as a database 124, comprised by the servers 108 or the device 104 or coupled thereto, for example, over the communications network 106. The database 124 may securely store data representations 120 to prevent unauthorized access and loss of sensitive data and may automatically store and sort the data representations as the associated events, actions, etc., occur. The data representations 120 and the narratives 122 may be requested and received using an application programming interface (API) via requests/calls and responses, for example, over the communications network 106, although other forms of communication such as Bluetooth and near-field communication are possible as well.

In a particular implementation, the servers 108 each comprise a central processing unit (“CPU”) 110, a non-transitory computer-readable memory 112, non-volatile storage 114, an input/output interface 116, and a graphical processing unit (“GPU”) 118. The non-transitory computer-readable memory 112 comprises computer-executable instructions stored thereon at runtime which, when executed by the CPU 110, configure the server to perform the herein described processes of narrative generation. The non-volatile storage 114 has stored on it computer-executable instructions that are loaded into the non-transitory computer-readable memory 112 at runtime. The input/output interface 116 allows the servers 108 to communicate with one or more external devices such as the device 104 (e.g., via network 106). The non-transitory computer-readable memory 112 may also have stored thereon the machine learning models 126. The GPU 118 may be used to control a display and may be used to process the data representations 120 to generate the narratives 122, including for example by running the machine learning models 126 to interpret the data representations 120, as described further herein. In some embodiments, the machine learning models 126 may be stored at one or more separate servers. For example, the LLM may be stored on an external server. Accordingly, it is possible to interface with the LLM for generating the narratives 122 through the use of APIs. Accordingly, it is possible to interface with the modules and/or the models 126 comprised therein for generating the narratives 122 through the use of APIs. The servers 108 and the device 104 may each provide a communications interface which allows software and data to be transferred, for example between the servers 108 and the device 104 over the communications network 106.

The CPU 110 and GPU 118 may be one or more processors or microprocessors, which are examples of suitable processing units, which may additionally or alternatively comprise an artificial intelligence accelerator, programmable logic controller, a microcontroller (which comprises both a processing unit and a non-transitory computer readable medium), neural processing unit (NPU), or system-on-a-chip (SoC). As an alternative to an implementation that relies on processor-executed computer program code, a hardware-based implementation may be used. For example, an application-specific integrated circuit (ASIC), field programmable gate array (FPGA), or other suitable type of hardware implementation may be used as an alternative to or to supplement an implementation that relies primarily on a processor executing computer program code stored on a computer medium.

It should be noted that while FIG. 1 depicts the device 104 and the servers 108 as separate entities coupled over the communication network 106, the device 104 and servers 108 may also be coupled directly/physically using cable(s) for data transfer. In some embodiments, the servers 108 may also be the device 104 or comprise the device 104 (e.g., the servers 108 being implemented as a part of a computer system). In such an embodiment, the servers 108 may directly retrieve the data representations 120 (as well as any other required data) from fixed local storage or removable local storage.

The process of generating narratives from embeddings is described below with reference to FIG. 2. Note that while the general framework is similar to that of the ELM, various differences from the ELM are highlighted herein.

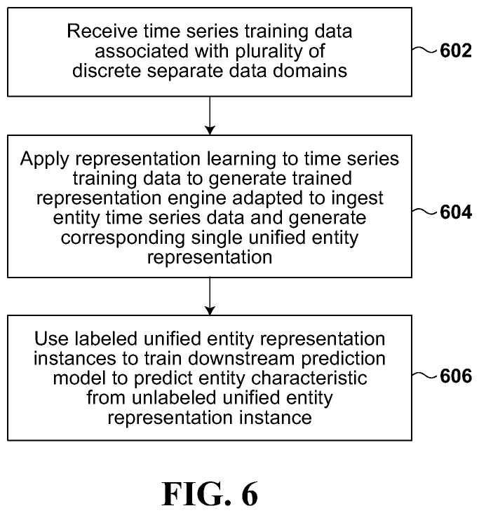

Referring to FIG. 2, a system comprising an adapter 204 and LLM 206 is used to generate narratives 122 from the data representations 120. The data representations 120 can comprise raw data such as tabular data, time-series data or logs and may be processed to generate embeddings 210 corresponding or representative of the data representations 120. To generate the embeddings 210, data representations 120 may be processed by data processing module 202, as depicted in FIG. 2. Specifically, the data representations 120 may be discrete event sequence data, particularly financial discrete event sequence data such as a series or sequence of transactions or financial activities. As another example, the data representations 120 may be a list of purchases or a list of products on a particular wish list. In some embodiments, the data representation may comprise natural language text such as descriptions in sentence, paragraph, and/or bullet form. In particular, the data processing module 202 may be one or more neural networks configured to process, characterize, transform, and/or standardize the data representations 120 into the embeddings 210 representation thereof. The data processing module 202 and the generation of embeddings 210 is described further herein with respect to FIG. 6. Data representations 120 can comprise a group of at least one data representation from which narratives 122 are to be generated, where the group can be referred to as a set. For example, a set of data representations can correspond to the transactions of a particular account for which narratives 122 are to be generated.

The embeddings 210 may represent higher-dimensional complex data, in this case the raw data of data representations 120 (e.g., words, time series-data, etc.), as lower-dimensional vectors in a continuous vector space. In particular, embeddings 210 may be dense representations of the data representations 120 and can comprise vectors comprising real-valued numbers, as opposed to sparse representations such as one-hot encoding, and where the (dense) vectors can be useful for capturing meaningful relationships or patterns within the data representations 120. That is, the data representations 120 may be transformed into number representations such that the embeddings 210 are the data representations 120 in vector form. For example, within the data representation 120, each entry (e.g., each transaction), each word, each data event in time series-data/logs, each row/column/cell in tabular data, etc. may be mapped to one or more numbers where the embeddings 210 comprise a plurality of vectors of the mapped numbers corresponding to the data representations 120, where each vector can represent an entry, a word, a data event, a row/column/cell etc. Specifically, the data representations 120 may be tokenized by the data processing module 202 to generate the embeddings 210, where the tokens can refer to the individual units or elements that data is broken down into during the preprocessing step (e.g., each entry, each word, data event, each row/column/cell, etc. of the data representation 120). Accordingly, each token can correspond to a vector, which itself corresponds to a position in the vector/embeddings space.

For each set of data representations 120, a set of one or more embeddings can be generated, which are referred to herein as embeddings 210. The embeddings 210 can reduce the size of high-dimensional data to lower-dimensional vectors to better facilitate data processing and computationally efficient processing thereof while preserving the original information in the data representations 120. In particular, the embeddings 210 (e.g., the vectors) may be constructed such that similar data points (e.g., similar words, images, or users) are placed closer together in the vector space where the distance between vectors represents semantic similarity. For example, in word embeddings, words with similar meanings can be represented by vectors that are close to each other in the vector space.

The embeddings 210, or alternatively the raw data of data representations 120, can be processed by the adapter 204 to generate the mapped or adapted embeddings 212. Notably, in the ELM framework, for each set of embeddings 210 or data representations 120, a single set of mapped embeddings 212 corresponding thereto is generated. Accordingly, a single machine learning model such as an MLP can be used. In contrast, the adapter 204 of the present disclosure is configured to generate a plurality of sets of mapped embeddings as the mapped embeddings 212. That is, for each set (e.g., a first set) of embeddings 210 or data representations 120, a plurality of sets of (e.g., second sets of) mapped embeddings are generated, where each set can comprise one or more individual mapped embeddings. The sets of embeddings can be concatenated as the mapped embeddings 212. Accordingly, the adapter 204 of the present disclosure can comprise one or more machine learning models to generate the plurality of sets of mapped embeddings. For example, a plurality of MLPs or an RNN can be used to generate multiple sets of embeddings as the mapped embeddings 212. Note that while a plurality of sets of mapped embeddings are generated, all sets of mapped embeddings correspond to (e.g., are generated from) the single set of data representations 120 or embeddings 210.

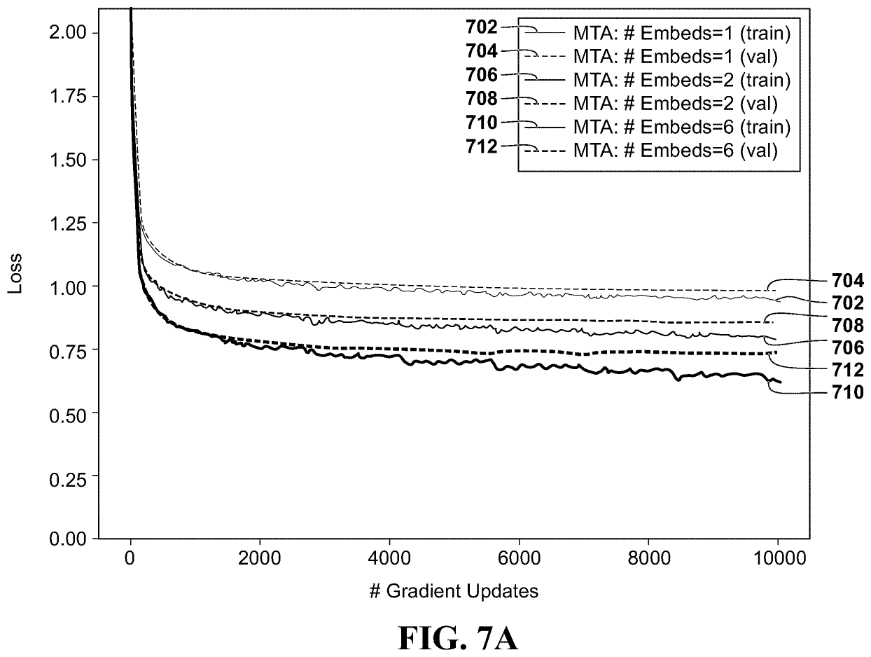

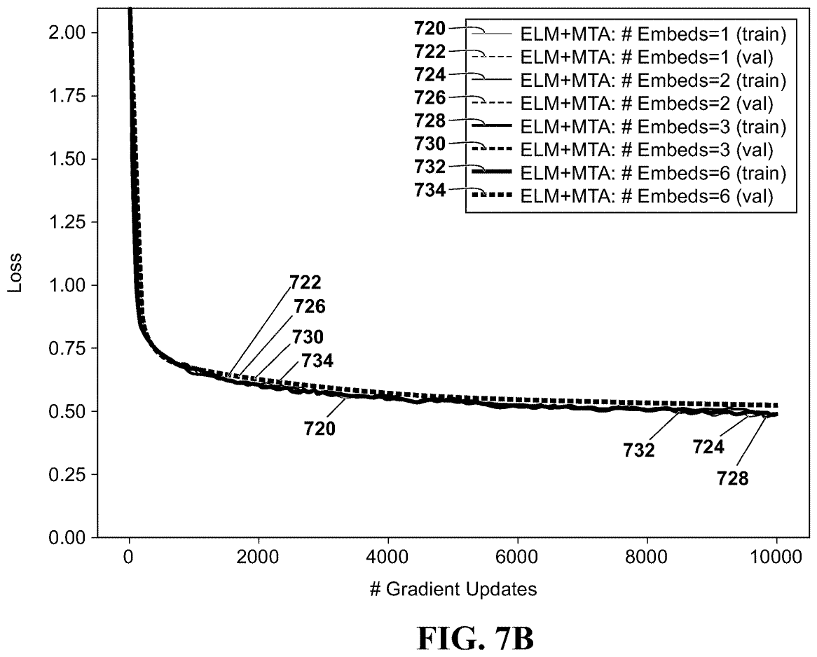

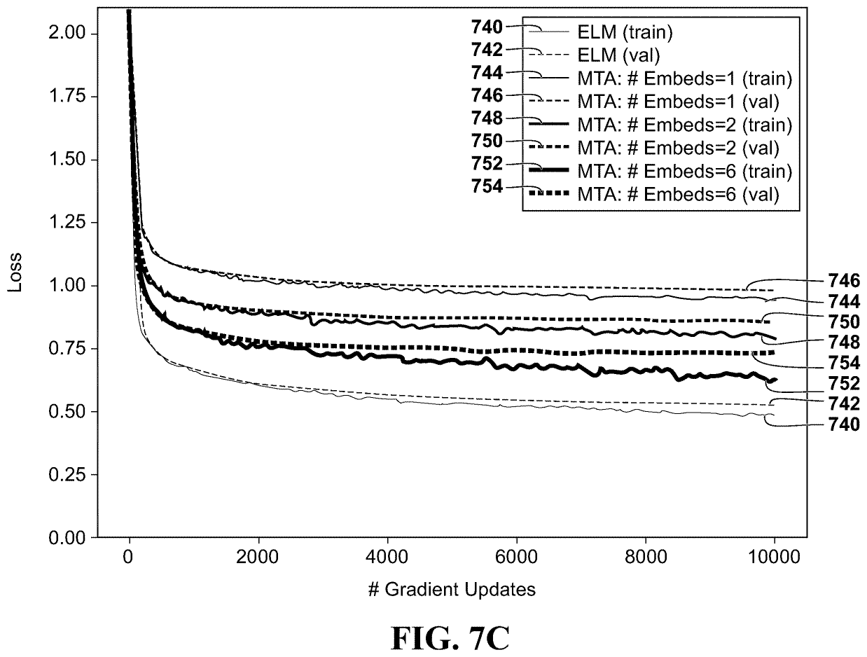

By generating more than one set of embeddings for interpretation by the LLM 206, the LLM 206 can be provided with additional data in the form of different/diverse context and/or perspectives for interpreting the data representation 120 in the form of the mapped embeddings 212. That is, rather than interpreting from a single set of (mapped) embeddings, the LLM 206 can improve its understanding of the data representations 120 by ingesting additional context from the additional sets of mapped embeddings. Accordingly, all or at least some sets of the mapped embeddings 212 should be distinct or different from one another. Further, as the LLM 206 ingests a plurality of sets of embeddings, each set of embeddings in the mapped embeddings 212 can be simpler and therefore easier for the LLM 206 to interpret. This approach may be more compatible with LLMs and can better align with the LLM's ability to handle individual linguistic concepts. For example, a plurality of simpler sets of mapped embeddings can be generated using the disclosed adapter as opposed to the ELM framework, where a single set of complex mapped embeddings is generated for interpretation by the LLM. As an example, while each set of mapped embeddings can match the dimension size of the LLM 206, each set of mapped embeddings can be simpler and may have a smaller (or larger) dimension size than the input embeddings 210. In some embodiments, the number of sets of mapped embeddings may be 3 to 6 or more. Note that increasing the number of sets of mapped embeddings incorporated in the mapped embeddings 212 can enhance the performance of the LLM 206 in interpreting the data representations 120 and generating meaningful narratives 122, as described further herein with reference to FIGS. 7A-7C.

The raw data and the embeddings 210 may correspond to or be represented in a first data domain. The adapter 204, for example, each machine learning model comprised therein, processes the raw data or embeddings 210 such that they are transformed or mapped to a second data domain, for example, as (one set of) the mapped embeddings 212. That is, the embeddings 210 may represent the data representations 120 in a first feature or vector space (e.g., first data domain), for example, having a first set of parameters thereof, while each set of mapped embeddings may represent the data representations 120 in a second feature or vector space (e.g., second data domain), for example, having a second set of parameters thereof. The adapter 204 can generate each set of mapped embeddings by mapping each of the vectors comprised in the embeddings 210, corresponding to the first feature space, into corresponding vectors in the second feature space as a set of mapped embeddings. That is, each set of embeddings in the mapped embeddings 212 comprises embeddings in the second feature space.

More specifically, the first and second feature spaces may have different dimensionality, and as such the adapter 204 can transform vectors of a first dimension (e.g., first data domain) in the embeddings 210 into vectors of a second dimension (e.g., second data domain) as the mapped embeddings, where the dimension of a feature or vector space can refer to a number of features or attributes that describe a data point or vector in the feature space. Further, vectors in the first feature space may have different magnitude, direction, and tokenization (e.g., how the words, items, actions, etc., are broken down into tokens) from vectors in the second feature space as well as having different basis vectors. As such, the adapter 204 can map the vectors in the embeddings 210 into the corresponding vectors in a set of mapped embeddings by mapping the vectors to account for the differences in these parameters or into the proper vectors having the corresponding parameters. More generally, the vector representations of the data representations 120 of the first data domain (e.g., embeddings 210) can be converted into vectors in the second data domain (e.g., mapped embeddings) corresponding to the data representations 120 being represented in the second data domain (e.g., feature space) by the adapter 204. In cases where data representations in the form of raw data are processed by the adapter 204, the adapter 204 can perform tokenization and vectorization to generate vectors of the second data domain from the raw data as the mapped embeddings 212. In some embodiments, the adapter 204 may also transform the mapped embeddings 212 into natural language text, for example, by converting the mapped vectors into natural language text or directly transforming the embeddings 210 into natural language.

In some embodiments, the adapter 204 can comprise or be implemented as a plurality of MLPs. In particular, each of the plurality of MLPs can be individually configured to transform a set of data representations 120 or embeddings 210 of the first data domain into a set of mapped embeddings of the second data domain, as described above. That is, each individual MLP comprising a portion of the adapter 204 may be configured to generate a set of mapped embeddings for each set of data representations 120 or embeddings 210. Accordingly, the mapped embeddings 212 comprise a plurality of sets of mapped embeddings, where each set of mapped embeddings can be generated by a respective one of the plurality of MLPs. For example, the number of sets of mapped embeddings can be equal to the number of MLPs comprised in the adapter 204. As such, to increase/decrease the number of sets of mapped embeddings, the number of MLPs comprised in the adapter 204 can be increased/decreased correspondingly. The plurality of sets of mapped embeddings from the plurality of MLPs can be combined (e.g., concatenated) to form the mapped embeddings 212 for interpretation by the LLM 206.

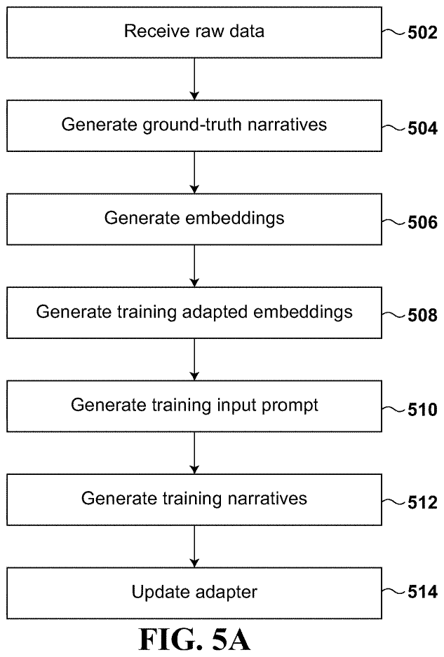

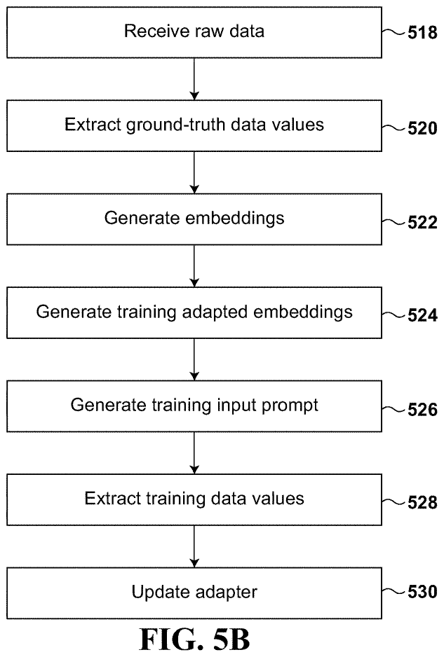

Note that each MLP may be a feedforward neural network consisting of input, hidden, and output layers, where each neuron in the hidden layers applies a non-linear activation function to learn patterns in the embeddings 210 to generate the corresponding mapped embeddings. Each neuron in the network may represent a feature. For example, the number of nodes may correspond to the dimension size (e.g., number of dimensions) in the embeddings 210. For each MLP to generate a distinct set of mapped embeddings and therefore provide the LLM 206 with different and diverse perspectives for interpretation, the MLPs can be jointly trained (e.g., as the adapter 204) with each MLP being initialized with distinct or unique (e.g., different) weights during training. The initial weights can be arbitrary or randomized. As such, the trained MLPs may have different weights and can therefore act as independent MLPs to generate distinct mapped embeddings from the same set of embeddings 210. Further details with regard to the training of the adapter 204 is described herein with respect to FIGS. 4A-5B.

In some embodiments, the adapter 204 can comprise or be implemented as an RNN such as a Long Short-Term Memory (LSTM) network or Gated Recurrent Unit (GRU) network to transform a set of data representations 120 or embeddings 210 of the first data domain into a plurality of sets of mapped embeddings of the second data domain, as described above. In such an embodiment, a single RNN-based network can be used to generate all sets of mapped embeddings forming the mapped embeddings 212 from the set of embeddings 210. In particular, the RNN can be run multiple times to sequentially generate the required number of sets of mapped embeddings (e.g., equal to the number of times the RNN is run), each of which can be distinct. For example, to increase/decrease the number of sets of mapped embeddings, the number of times the RNN is sequentially run can be increased/decreased correspondingly. The generated sets of mapped embeddings can be combined (e.g., concatenated) to form the mapped embeddings 212 for interpretation by the LLM 206. The RNN may comprise a plurality of layers, each with its own set of weights for mapping the embeddings 210 from the first data domain to the second data domain. Each layer can correspond to an aspect of the transformation. For example, each layer can receive as input the output of the lower layer and can refine (e.g., increase dimensionality) or abstract (e.g., decrease dimensionality) the features defined by the lower layer in order to map the vectors from the first vector space to the second vector space. Note that each run of the RNN may be inherently sequential, where each output (e.g., each set of mapped embeddings) can depend on previous time steps (e.g., previous sets of mapped embeddings and/or embeddings 210). For example, each set of mapped embeddings can be a set of mapped embeddings that is generated at a particular time step by the RNN, and as such, each set of mapped embeddings can be distinct. The sampling time steps for outputting the sets of mapped embeddings can be chosen based on runtime and/or accuracy and are not required to be adjacent (but can be adjacent). Accordingly, the sets of mapped embeddings generated by the RNN can have dependencies therebetween, which can provide the LLM 206 with a more structured representation of or context on the data representation 120 for interpretation by the LLM 206.

As depicted in FIG. 2, the narratives 122 are generated by the LLM 206. As such, in order to process the data representations 120 using the LLM 206, the mapped embeddings 212 should be in a format that the LLM 206 is trained to operate on. For example, the second data domain may correspond to the data domain that the LLM 206 is trained on. In some embodiments, the adapter 204 is configured to generate mapped embeddings 212 as language token embeddings from the embeddings 210, which are more suitable for LLM processing.

The mapped embeddings 212 can be processed by the LLM 206 to generate the narratives 122. The LLM 206 can be a pre-trained LLM that is frozen during the training of the adapter 204. In particular, the unmodified pre-trained LLM 206 is used for narrative generation. To facilitate the LLM 206 in interpreting mapped embeddings 212 corresponding to the data representations 120, the mapped embeddings may be incorporated in an input prompt 216. In particular, to interact with the LLM 206, the input prompt 216 can be formulated using dialogues with concise and well-structured language, similar to chatting with the LLM 206. The input prompt 216 may be displayed to the user 102, which can also help the user 102 in understanding the task being performed and the narratives 122 being generated, but is not required. A number of different LLMs may be implemented as the LLM 206; for example, the LLM 206 can be implemented using Ilama-3™, Phi3 Mini™, OpenAI™, etc. LLMs. Different LLMs, for example LLMs with different architectures, can each have their own specialized chatting template or format requirement for the input prompt 216. As such, the input prompt 216 may be adapted depending on the prompt requirement of the specific LLM that is used for processing to accordingly build the dialogue using specially crafted prompts. For example, Ilama-3™ based LLMs can pre-define three roles for each conversation session, which are {system, user, assistant}, and set up a discussion panel among these roles, where the system role and user role correspond to and can be fulfilled by the input prompt 216 and the assistant role corresponds to the output of the LLM 206 (e.g., the narratives 122).

In some embodiments, the input prompt 216 can be formulated as a conversation in a way similar to talking to professionals relevant to the field of the data representations 120. For example, to interpret data representations 120 pertaining to financial data such as financial transactions, the input prompt 216 may be formulated as a conversation with a financial professional. For example, the input prompt 216 may frame the LLM 206 as a professional in a field pertaining to the data representations 120 or otherwise limit or identify the field pertaining to the data representations 120. As such, the LLM 206 can better understand the context of the data representations 120, for example the terminology and data in the context of the related field (e.g., finance) and accordingly generate narratives that are more relevant to the field (e.g., finance). That is, the input prompt 216 can comprise instructions for the LLM 206 to generate the narratives 122, where the instructions are oriented to a field relevant or pertaining to the data representations 120 (e.g., mapped embeddings 212) by providing the LLM 206 with a specialized role in the field or otherwise identifying the field.

An example input prompt 216 and the corresponding narratives 122 generated by the LLM 206 are shown below in Table 1. In this example, the LLM 206 is implemented using the Ilama-3™ LLM. In the example shown in Table 1, financial narratives are generated using a series of financial transactions captured as the data representations 120.

TABLE 1
Example Input Prompt and Generated Narratives

| Role | Messages |
|---|---|
| System | You are an expert in the financial sector who has extensive knowledge |
| | of personal chequing transaction data and can provide deep analysis |
| | on the client's financial situation. <STOP> |
| User | Here is the embedding of personal chequing transaction history: |
| | <embeddings>. Please generate a high-level description of this client's |
| | financial behaviour. <STOP> |
| Assistant | The account holder shows a balanced approach to managing income |
| | and expenses. They prioritize essential expenses like rent, utilities, and |
| | groceries while also allowing for discretionary spending on dining out, |
| | shopping and subscriptions. Regular savings transfers indicate a focus |
| | on financial security and planning. <STOP> |

In Table 1, <STOP> indicates the end of the sentence, prompt, or message. The mapped embeddings 212 are provided to the LLM 206 as a part of the input prompt 216, shown in Table 1 as <embeddings> for simplicity. The messages from the roles identified as system and user correspond to the input prompt 216, and the message from the assistant corresponds to the narratives 122, interpreted from the mapped embeddings 212 by the LLM 206, which is a sequence of high-quality client narratives. It should be noted that, as depicted in Table 1, the input prompt 216 can comprise natural language messages with the mapped embeddings 212 embedded therein as vectors (e.g., a combination of natural language text and vectors). The LLM 206 can ingest the input prompt 216 as language token embeddings, as the vectors in the mapped embeddings 212 are in the data domain that the LLM 206 is trained to operate on. In some embodiments, it is also possible to represent the entirety of the input prompt 216 using vector representation. For example, vector representations can be generated by tokenizing the natural language text comprised in the input prompt 216. In particular, a text encoder can be used to encode the input prompt 216 into vectors. In some embodiments, the entirety of the input prompt 216 can be represented using natural language, for example, in cases where the mapped embeddings 212 are in natural language or by converting the mapped embeddings 212 to natural language.

As shown in Table 1, the input prompt 216 can comprise a plurality of prompts 214, such as a first and a second prompt. In particular, the first prompt may be a system prompt, for example, corresponding to the message provided as the system role in Table 1. The system prompt can provide the LLM 206 with background, context, or a role for interpreting the data representations 120 captured as the mapped embeddings 212, for example by identifying the relevant field of expertise pertaining to the data representations 120 as described above. The system prompt can also provide the LLM 206 with a high-level description of the task that it needs to perform, for example, providing insights or analysis in a particular field without specifying the specific narratives that the LLM 206 should generate. Accordingly, the system prompt can give high-level instructions to LLM 206, set the tone of the narratives 122 (e.g., the LLM response) as well as provide a general description of the second prompt (described below), for example a context of the second prompt and the data representations 120. Note that the system prompt can also comprise a general description of the narratives 122 for generation by the LLM 206 or comprise a general overview/description of the narratives 122 or type thereof.

The second prompt may be a narrative prompt comprising the mapped embeddings 212 and defining the specific narratives to be generated by the LLM 206. The narrative prompt can provide context for mapped embeddings 212, for example by describing what information is represented or encapsulated by the mapped embeddings 212 for improved LLM interpretation. In particular, the narrative prompt can provide more detailed and specific instructions to the LLM 206, for example by defining the specific type(s) of narratives to be generated and/or the specific contents of the narratives to be generated. That is, the narrative prompt can define the exact type of insights or recommendations to be generated as the narratives 122. For example, the narrative prompt can define the narratives 122 by requiring the LLM 206 to identify patterns/items of interest, identify key findings, as well as provide predictions/estimations/conclusions/recommendations. The narrative prompt can also define requirements or rules for the narratives 122 generated by the LLM 206. For example, the narrative prompt can define a data or file type for the narratives 122, a format/formatting for the narratives 122, or acceptable or unacceptable answers/choices/values for output as the narratives 122. The narrative prompt can be manually designed and may include generic natural language requests such as “Please assess the client's financial situation from the perspectives of income consistency, spending habits, savings behaviour, existing financial obligations, and overall cash flow,” or give instructions with specific purposes such as “Please predict whether the client would be interested in redeeming the credit card reward point for flights based on the transaction history and explain the prediction with three reasons.” Some example requirements are shown below:
“Summarize the response using no more than X bullet points”;
Enumerate the bullet points in the response from 1 up to X″;
“Do not use specific numbers or details from the provided data (e.g., mapped embeddings 212) in the response”;
“Provide your response in the format of a JSON file containing a list of items”;
“Each item in the response should correspond to one recommendation”;
   “1) “recommendation_id”: the id of the recommendation in a single digit from 1 to X;
   2) “recommendation_rank”: the rank of the recommendation by preference in a single digit from 1 to X where 1 is the highest ranking and X is the lowest;
   3) “recommendation”: the content of the recommendation in a string;
   4) “reason”: the reason for the ranking of the recommendation in a string”;
“Do not include any additional text other than the JSON file”; and
“the valid recommendations are: 1) . . . , 2) . . . . X) . . . ”.

The input prompt 216 can be generated by concatenating or combining the first and second prompts, or inputting them into the LLM 206 sequentially. Further, once the first prompt is provided to the LLM 206, multiple queries to the LLM 206 using only the second prompt are possible. For example, the user 102 may wish to generate a plurality of narratives 122 for a plurality of data representations 120 pertaining to the same field. In such a case, once the first prompt for identifying the field is processed by the LLM 206, the input of the first prompt to identify the same field for the LLM 206 for subsequent interpretation of subsequent data representations may be omitted (e.g., between narrative generation), as the relevant field or the role of the LLM 206 can be preserved between queries. As such, second prompts comprising the mapped embeddings 212 can be input sequentially until a set of data representations pertaining to a different field needs to be interpreted. In some embodiments, the system prompt may be omitted from the input prompt 216 entirely or be comprised as a part of the narrative prompt, for example, in cases where the LLM 206 does not accept system prompts (e.g., Phi3 Mini™ LLM).

In some embodiments, the input prompt 216 may be generated according to a prompt template or to a particular format. For example, the input prompt may be generated as a concatenation of the first and second prompts (e.g., <system prompt>+<narrative prompt>), as described above. The first and second prompts may also be generated according to a particular prompt template, for example out of a plurality of prompt templates where the appropriate template may be determined automatically or selected manually by the user 102. As an example, the first prompt can correspond to one of a plurality of prompt templates each corresponding to a role-defining prompt of a particular field. The first prompt can then be selected based on the field pertaining to the data representations 120. For example, for finance-oriented data representations 120, a prompt defining the LLM 206 as a finance expert can be selected as the first prompt. The template can also correspond to the type of data in the data representations 120 as well as the desired type of narratives 122 to be generated. For example, a prompt template for the first prompt can specify that the data representations 120 (e.g., mapped embeddings 212) correspond to financial transactions to indicate the type of data as financial and also specify that the LLM 206 should be providing recommendations based on the transactions as to indicate the desired type of narratives 122 to be generated. The second prompt can also be generated according to one of a plurality of templates in a manner analogous to the process described with regard to the generation of the first prompt. For example, the second prompt can be selected as one of a plurality of templates based on the data representations 120 and the desired types of narratives 122 to be generated. For example, a prompt template for the second prompt may correspond to the generation of recommendations as the narratives 122, where the prompt template may list the number of available and acceptable offers as well as instructions to rank the recommendations. To generate a different type of narrative, a different prompt template corresponding to the desired narrative type may be used. As another example, a prompt template for the second prompt may describe the format or structure of the data representations 120, specifically the mapped embeddings 212, to help the LLM 206 better interpret the mapped embeddings 212. For mapped embeddings in a different format, a different prompt template corresponding to the particular format can be used. The templates for the second prompt can also comprise placeholders, for example to facilitate the insertion of the mapped embeddings 212 into the second prompt.

In some embodiments, one or more prompts 214, specifically the first and/or second prompts, can be generated using a second LLM 208. The implementation of the LLM 208 is not restrictive and may be a pre-trained LLM such as the Llama-3 LLM. The LLM 208 can generate queries targeting specific narratives to be generated by the LLM 206, for example, interpreting specific aspects of the mapped embeddings 212 or generating a specific type of narrative such as recommendations. This approach can leverage the prior knowledge of LLMs learned from massive amounts of data during pre-training. The queries provided to the second LLM 208 for generating the prompts 214 can specify the types of prompts 214 to be generated by the LLM 208 as well as requirements thereof, such as not including specific numbers or details in the prompts 214. The prompts generated by the LLM 208 may be used to generate the input prompt 216 directly or formatted and saved as prompt templates for later use.

As described above, requests for the LLM 206 to generate narratives can be chained. That is, the system may be required to interpret a plurality of sets of data representations 120 to generate a plurality of sets of narratives 122. Accordingly, the input prompt 216 can comprise various different sets of mapped embeddings 212 which are combined or concatenated. In some embodiments, the same prompts (e.g., system prompt) in the prompts 214 can be shared for different sets of mapped embeddings 212 corresponding to different data representations 120. In such cases, the same prompts can be omitted for the subsequent sets of mapped embeddings 212.

As depicted in FIG. 2, the LLM 206 processes the input prompt 216 comprising the mapped embeddings 212 to generate the narratives 122. The training of the adapter 204 and the LLM 206 to generate the narratives 122 is described further herein with respect to FIGS. 4A-4C.

As shown in FIG. 2, the LLM 206 generates the narratives 122, which can be returned to the user 102. In some embodiments, the narratives 122 may be required to be output in a specific format, for example, by the user 102 via an overall prompt to the system of FIG. 2. That is, the user 102 may specify the data representations 120 to be interpreted as well as the narrative 122 to be generated. In some embodiments, the user 102 may specify that the narratives 122 should be formatted as a text message, a Multimedia Messaging Service (MMS) message, a text/PDF file (e.g., a report), an email, etc. Further, the system of FIG. 2 can additionally perform tasks corresponding to the request of the user 102, for example, sending the narratives 122 as a message or email.

Note that while the second LLM 208 is shown and described as generating the prompts 214, a different LLM such as the LLM 206 may be used instead. Additionally, the second LLM 208 may be implemented using the same model as the LLM 206.

Note that while the embeddings 210 are described above as corresponding to a first data domain, in some embodiments, the data representations 120 may also correspond to the first data domain. In other embodiments, the data representations 120 may correspond to a data domain different from the first data domain (e.g., a third data domain) where the data processing module transforms/maps the data representation 120 from the third data domain to the first data domain (e.g., as embeddings). For example, the first data domain can correspond to vector embeddings while the third data domain can correspond to natural language domain (e.g., tabular/sequential data). While the third data domain can be different from the second data domain, in some embodiments, the third data domain and the second data domain can be the same data domain (e.g., natural language domain).

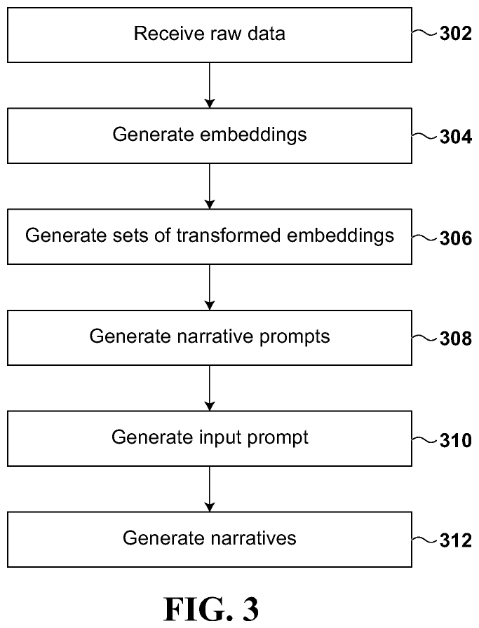

Referring now to FIG. 3, a method for generating narratives from data representations using the system of FIGS. 1 and 2 is depicted, according to an example embodiment. At 302, data representations 120 comprising raw data may be received or retrieved. The data representations may pertain to a particular field and may comprise a series of events or activities. At 304, the data representations 120 may be processed by the data processing module 202 to generate embeddings 210 corresponding to the data representations 120. The data processing module 202 can be a machine learning model trained to extract embeddings 210 from the raw data representations 120, as described with respect to FIG. 2 and further herein with respect to FIG. 6. The embeddings 210 may comprise a plurality of vectors and may correspond to a first data domain. At 306, the embeddings 210 may be mapped or transformed by the adapter 204 to generate the mapped embeddings 212, corresponding to a second data domain that is recognized by the LLM 206. The mapped embeddings 212 can comprise a plurality of sets of mapped embeddings, all corresponding to the embeddings 210. The adapter 204 is trained to perform vector mappings, as described with respect to FIGS. 4B and 4C. For example, the vectors comprised by the embeddings 210 may correspond to a first feature space having a first dimension, defined by the first data domain. The adapter 204 can perform vector mapping on the vectors comprised by the embeddings 210 to generate vectors corresponding to a second feature space having a second dimension, defined by the second data domain, where each set of the mapped vectors can correspond to a set of mapped embeddings in the mapped embeddings 212.

In particular, the adapter 204 can comprise a plurality of independent MLPs or an RNN. The adapter 204 can generate a plurality of sets of mapped embeddings, which are combined to form the mapped embeddings 212. Each set of mapped embeddings can correspond to a mapping of the embeddings 210 from the first data domain to the second data domain. In embodiments where the adapter 204 comprises MLPs, each MLP can be configured to generate one of the plurality of sets of mapped embeddings, where each MLP can be initialized with distinct weights during training (e.g., each initialized with a distinct set of weights). The plurality of sets of mapped embeddings are independently generated and may be distinct from one another. In embodiments where the adapter 204 comprises an RNN, the plurality of sets of mapped embeddings can be generated sequentially by a single RNN, for example corresponding to the output from the RNN at different time sample steps. In such cases, there can be dependencies between the sets of mapped embeddings.

At 308, the one or more prompts 214 comprising the system prompt and the narrative prompt can be generated. The one or more prompts 214 can be generated according to a prompt template and may be generated using a second LLM 208. The one or more prompts 214 can comprise a first prompt corresponding to a system prompt providing the LLM 206 with background, context, or role for interpreting the data representations 120 and can, for example, identify a field relevant to the data presentations 120. The one or more prompts 214 can also comprise a second prompt corresponding to one or more narrative prompts that comprises the mapped embeddings 212; define the type(s) of narratives 122 to be generated; and/or define rules for generating the narratives 122. At 310, the input prompt 216 comprising the prompts 214 and the mapped embeddings 212 can be generated. At 312, the input prompt 216 is processed by the LLM 206 to generate the narratives 122, for example by interpreting the data representations 120 as represented by the mapped embeddings 212. Note that the LLM 206 can be a pre-trained LLM that is unmodified during the training process.

FIGS. 4A-4C depict the training of machine learning models to perform narrative generation, first with respect to the ELM framework (FIG. 4A), then with respect to the system of FIGS. 1 and 2 (FIGS. 4B and 4C).

Referring to FIG. 4A, a method of training the machine learning models in an ELM framework to perform data representation interpretation to generate the narratives 122 is depicted, according to an example embodiment. As depicted in FIG. 4A, training data 402 comprising training data representations is obtained. The training data representations can comprise raw data and may pertain to a particular field and may comprise a series of events or activities. The training data representations 402 may be processed by the data processing module 202 to generate training embeddings 416 corresponding to the training data representations, as described above with respect to FIG. 2. The training embeddings 416 may comprise a plurality of vectors and may correspond to a first data domain.

During training, the adapter 204 processes the training embeddings 416 to generate training mapped or adapted embeddings 412 from the training embeddings 416. The training mapped embeddings 412 can correspond to a second data domain (e.g., vectors) an LLM 414 recognizes or is trained to operate on, or is intended for the LLM 414 to operate on. The aim of the training process is for the adapter 204 to suitably map the training embeddings 416 from the first data domain to the second data domain as the training mapped embeddings 412 such that the LLM 414 is able to interpret the training mapped embeddings 412. Note that only one set of training mapped embeddings 412 is generated for each set of training embeddings 416.

The training mapped embeddings 412 and one or more prompts 404 can be used to generate a training input prompt 406. The one or more prompts 404 can comprise a first prompt corresponding to a system prompt and a second prompt corresponding to one or more narrative prompts and may be generated using the second LLM 208, as described above with respect to FIG. 2.

As depicted in FIG. 4A, ground-truth narratives 408 may be provided to the LLM 206 for training as training targets. The ground-truth narratives 408 may correspond both to the training data 402 and the instructions outlined in the training input prompt 406. For example, a training input prompt 406 can comprise an instruction to: “Provide a high-level description on this client's financial behaviour”. Correspondingly, the ground-truth narratives 408 may be: “The account holder shows a balanced approach to managing income and expenses . . . ”, which can be the narratives a professional in the field would be able to interpret from the training data 402 in accordance with the requirements outlined in the training input prompt 406. Note that the instruction to generate the ground-truth narratives 408 can be substantially the same as those included in the training input prompt 406 and may also be generated using the second LLM 208 in an analogous manner.

To generate the ground-truth narratives 408, the training data representations comprising raw data can be used. In particular, the training data representations may be in natural language or converted to natural language. For example, the data representations may comprise data corresponding to a series of sequential events where the data representations may be represented as a table in natural language format (e.g., text) identifying each event, as described above with respect to FIG. 2. A query can be generated using the text data representations and provided to a pre-trained LLM 206 to generate the ground-truth narratives 408. As an example, the query can comprise the data representation in natural language such as: “Here is the personal chequing transaction history table: . . . |transaction date|transaction category|transaction amount|2021 Aug. 3|External Pre-Authorized Payment (Chargeable)|163.15$|2021 Aug. 4|Cheque Deposit|800.0$| . . . etc.”. The pre-trained LLM 206 can interpret the natural language training query as available LLMs have seen similar data during training (e.g., sequential event sequences) and as such can reason over or interpret the natural language training data to generate corresponding narratives in accordance with the instructions in the query as the ground-truth narratives 408 without supervision. Specifically, the pre-trained LLM 206 is trained to ingest the training data representations (e.g., raw data), which, while they may be in a form such as tabular data, are still considered to be in natural language. The process for generating the query for generating the ground-truth narratives 408 is analogous to the process of generating the input prompt 216, as described with respect to FIG. 2, with the difference being that the data representations are represented using natural language instead of mapped embeddings 212 (e.g., vectors). That is, the LLM 206 may be a pre-trained LLM that is not trained to directly recognize mapped embeddings, for example as vectors, but had been trained for natural language processing. Accordingly, the pre-trained LLM 206 can ingest the training data representations and the narrative generation instructions to generate the ground-truth narratives 408.

An example of training data 402 corresponding to financial activities is shown below:
   |transaction date|transaction category|transaction amount|
   |20xx-08-03|External Pre-Authorized Payment (Chargeable)|173.15$|
   |20xx-08-04|Cheque Deposit|500.0$|
   |20xx-08-07|External Pre-Authorized Payment (Chargeable)|600.0$|
   |20xx-08-07|Internal Transfer of Funds to Deposit between Accounts Online|8900.0$|
   |20xx-08-07|Manual Payment of Loan using Internet Banking|13000.0$|
   |20xx-08-09|Cheque Deposit|1272.0$|
   |20xx-08-15|Deposit of Payroll, Government, Tax, and Other Funds|15.0$|
   |20xx-08-16|Loan Interest Charged|13.13$|
   |20xx-08-21|Cheque Deposit|1600.0$|
   |20xx-08-23|Recurring Seniors Rebate|7.0$|
   |20xx-08-23|Monthly Banking Fee|10.95$|
   |20xx-08-28|External Pre-Authorized Payment (Chargeable)|399.97$|
   |20xx-08-31|E-Transfer Received into the Account Holder's Email|4175.43$|
   |20xx-09-01|Cash Withdrawal from Personal Touch Banking|13.2$|
   |20xx-09-01|Cash Withdrawal from Personal Touch Banking|256.05$|
   |20xx-09-01|External Pre-Authorized Payment (Chargeable)|310.0$|
   |20xx-09-05|External Pre-Authorized Payment (Chargeable)|145.78$|
   |20xx-09-05|External Pre-Authorized Payment (Chargeable)|175.0$|
   |20xx-09-08|Scheduled Internal Payment to Credit Card or InvestEase |2935.91$|
   |20xx-09-12|External Pre-Authorized Payment (Chargeable)|537.94$|
   |20xx-09-13|E-Transfer Received into the Account Holder's Email|242.13$|
   |20xx-09-15|External Pre-Authorized Payment (Chargeable)|483.0$|
. . .
   Note that the training data 402 (e.g., the data representations) may be represented as text in a tabular format, corresponding to a plurality of sequential events. For example, each row in the table takes a line of the table and columns can be separated by delimiters like commas or vertical bars. The first line of the table in text format may comprise a header showing the name of each column corresponding to the type of data in each column, separated by the same delimiter. The rows of the table can be ordered or grouped by a column of the table such as date or the data type. In the above example, the table comprises a series of financial transactions as the data representations in the training data 402, where entries are ordered based on the time of occurrence.

As depicted in FIG. 4A, the LLM 414 can interpret or process the training input prompt 406 to generate narratives 410, which can be evaluated against the ground-truth narratives 408. More specifically, the ELM system comprising the adapter 204 and the LLM 414 can be trained using token representation. That is, the ELM system can be trained to predict, from the training input prompt 406, each token of the ground-truth narratives 408 in sequence, where the natural language ground-truth narratives 408 can be tokenized for training. The system, in particular the adapter 204, may be trained using a loss formulated as the negative log-likelihood (NLL) of each predicted token in the sequence of tokens corresponding to the ground-truth narratives 408. The loss can be used to update the parameters (e.g., weights) of the adapter 204. Note that the LLM 414 may be a pre-trained LLM that is frozen during the initial training process, for example, during the training of the adapter 204. However, the LLM 414 is unfrozen during fine-tuning (e.g., after pre-training of the adapter 204) such that the adapter 204 and the LLM 414 are fine-tuned jointly. As such, both the LLM 414 and the adapter 204 are updated/modified during fine-tuning. For example, the LLM 414 may be a copy of or identical to the pre-trained LLM 206 prior to fine-tuning but will differ from the pre-trained LLM 206 once modified/updated during fine-tuning. Once fully trained, even without the data representations being represented in natural language (e.g., individual events in text/table format), the ELM system (e.g., LLM 414) can generate coherent and accurate narratives, for example, directly from the mapped embeddings 212 (e.g., vectors). It will be understood that the LLM 414 (prior to fine-tuning) may be used as the pre-trained LLM 206 for generating the ground-truth narratives 408.

Now referring to FIG. 4B, training of the adapter of the system of FIGS. 1 and 2 is depicted, according to an example embodiment. Analogous to FIG. 4A, training data 402 comprising training data representations is obtained. The training data representations can comprise raw data and may pertain to a particular field and may comprise a series of events or activities. The training data representations 402 may be processed by the data processing module 202 to generate training embeddings 416 corresponding to the training data representations, as described above with respect to FIG. 2. The training embeddings 416 may comprise a plurality of vectors and may correspond to a first data domain.

During training, the adapter 204 processes the training embeddings 416 to generate training mapped or adapted embeddings 412 from the training embeddings 416. The training mapped embeddings 412 can correspond to a second data domain (e.g., vectors) the pre-trained LLM 206 recognizes or is trained to operate on, or is intended for the pre-trained LLM 206 to operate on.

In contrast to the training process depicted in FIG. 4A, the aim of the training process is for the adapter 204 to suitably map the training embeddings 416 from the first data domain to the second data domain as the training mapped embeddings 412 such that the pre-trained LLM 206 is able to interpret the training mapped embeddings 412 without having to be fine-tuned with the adapter 204. In this case, a plurality of sets of training mapped embeddings can be generated for each set of training embeddings 416, as described above with respect to FIG. 2. The plurality of sets of training mapped embeddings can then be combined or concatenated to form the training mapped embeddings 412.

In some embodiments, the adapter 204 can comprise a plurality of MLPs, equal to a desired number of sets of mapped embeddings for LLM interpretation. During training, each MLP in the adapter 204 can be configured to independently map the training embeddings 416 from the first data domain to the second data domain as a set of training mapped embeddings (in the training mapped embeddings 412). At the start of training, each MLP can be initialized with a different or distinct set of weights. The initial weights are not restrictive and may be chosen using various methods such as randomization or weight sampling from a distribution of weights. The sets of weights are updated during training and once trained, each MLP can still have a different or distinct set of weights from the other MLP(s). Accordingly, each set of training mapped embeddings in the training mapped embeddings 412 may be distinct and can therefore provide the pre-trained LLM 206 with additional context for interpreting the training data 402. As the pre-trained LLM 206 can take all sets of training mapped embeddings as input (training mapped embeddings 412), the plurality of MLPs may be jointly trained. Note that while all sets of training mapped embeddings generated by the plurality of MLPs correspond to the same set of training embeddings 416, each set of training mapped embeddings may be independent of or distinct from the other sets of training mapped embeddings.

In some embodiments, the adapter 204 can comprise an RNN. During training, the RNN can be configured to sequentially generate a plurality of sets of training mapped embeddings (forming the training mapped embeddings 412). Each set of training mapped embeddings can correspond to a mapping of the training embeddings 416 from the first data domain to the second data domain by the RNN. To sequentially generate a plurality of sets of training mapped embeddings, the RNN may be run multiple times to generate the desired number of sets of mapped embeddings for LLM interpretation, for example by taking the output of the RNN at predetermined sample time steps. The chosen sample time steps may be determined in various ways such as experimentally or may be determined (e.g., chosen at the start of training) randomly. Note that as all sets of training mapped embeddings may be generated by the same RNN sequentially from the same set of training embeddings 416, dependencies can inherently exist between some or all sets of training mapped embeddings. The dependencies can provide a more structured representation of the training data 402 for interpretation by the pre-trained LLM 206.

Analogous to FIG. 4A, the training mapped embeddings 412 and one or more prompts 404 can be used to generate a training input prompt 406. The one or more prompts 404 can comprise a first prompt corresponding to a system prompt and a second prompt corresponding to one or more narrative prompts and may be generated using the second LLM 208, as described above with respect to FIG. 2. Ground-truth narratives 408 may be provided to the pre-trained LLM 206 for training as training targets. The ground-truth narratives 408 may correspond both to the training data 402 and the instructions outlined in the training input prompt 406. To generate the ground-truth narratives 408, the training data representations comprising raw data can be used. For example, the pre-trained LLM 206 can process the training data 402 (e.g., raw data) with the narrative generation instructions to generate the ground-truth narratives 408. Note that the instruction to generate the ground-truth narratives 408 can be substantially the same as those included in the training input prompt 406 and may also be generated using the second LLM 208 in an analogous manner.

As depicted in FIG. 4B, the pre-trained LLM 206 can interpret or process the training input prompt 406 to generate narratives 410, which can be evaluated against the ground-truth narratives 408 in a manner analogous to that described with respect to FIG. 4A. Specifically, the adapter 204 can be trained using token representation where the system as a whole is trained to predict, from the training input prompt 406, each token of the ground-truth narratives 408 in sequence, where the natural language ground-truth narratives 408 can be tokenized for training. The adapter 204 may be trained using a loss formulated as the negative log-likelihood (NLL) of each predicted token in the sequence of tokens corresponding to the ground-truth narratives 408. The loss can be used to update the parameters (e.g., weights) of the adapter 204, for example, each of the jointly trained MLPs or the RNN, as the case may be. Note that the pre-trained LLM 206 is frozen during the entire training process (e.g., pre-training and fine-tuning) and as such is entirely unmodified throughout, even once the system is completely trained. Once fully trained, even without the data representations being represented in natural language (e.g., individual events in text/table format), the pre-trained LLM 206 can generate coherent and accurate narratives, for example, directly from the mapped embeddings 212 (e.g., vectors).

Now referring to FIG. 4C, a variation of the training of the adapter of the system of FIGS. 1 and 2 is depicted, according to an example embodiment. Analogous to FIGS. 4A and 4B, training data 402 comprising training data representations is obtained. The training data representations can comprise raw data and may pertain to a particular field and may comprise a series of events or activities. The training data representations 402 may be processed by the data processing module 202 to generate training embeddings 416 corresponding to the training data representations, as described above with respect to FIG. 2. The training embeddings 416 may comprise a plurality of vectors and may correspond to a first data domain.

Analogous to FIG. 4B, the adapter 204 processes the training embeddings 416 to generate training mapped or adapted embeddings 412 from the training embeddings 416 during training. The training mapped embeddings 412 can correspond to a second data domain (e.g., vectors) the pre-trained LLM 206 recognizes or is trained to operate on, or is intended for the pre-trained LLM 206 to operate on. Also analogous to FIG. 4B, the aim of the training process is for the adapter 204 to suitably map the training embeddings 416 from the first data domain to the second data domain as the training mapped embeddings 412 such that the pre-trained LLM 206 is able to interpret the training mapped embeddings 412 without having to be fine-tuned with the adapter 204. As such, a plurality of sets of training mapped embeddings can be generated for each set of training embeddings 416, as described above with respect to FIG. 2. The plurality of sets of training mapped embeddings can then be combined or concatenated to form the training mapped embeddings 412.

In some embodiments, the adapter 204 can comprise a plurality of MLPs, equal to a desired number of sets of mapped embeddings for LLM interpretation. During training, each MLP in the adapter 204 can be configured to independently map the training embeddings 416 from the first data domain to the second data domain as a set of training mapped embeddings (in the training mapped embeddings 412). At the start of training, each MLP can be initialized with a different or distinct set of weights. The initial weights are not restrictive and may be chosen using various methods such as randomization or weight sampling from a distribution of weights. The sets of weights can be updated during training and once trained, each MLP can still have a different or distinct set of weights from the other MLP(s). Accordingly, each set of training mapped embeddings in the training mapped embeddings 412 may be distinct and can therefore provide the pre-trained LLM 206 with additional context for interpreting the training data 402. As the pre-trained LLM 206 can take all sets of training mapped embeddings as input (training mapped embeddings 412), the plurality of MLPs may be jointly trained. Note that while all sets of training mapped embeddings generated by the plurality of MLPs correspond to the same set of training embeddings 416, each set of training mapped embeddings can be independent of or distinct from the other sets of training mapped embeddings.

In some embodiments, the adapter 204 can comprise an RNN. During training, the RNN can be configured to sequentially generate a plurality of sets of training mapped embeddings (forming the training mapped embeddings 412). Each set of training mapped embeddings corresponds to a mapping of the training embeddings 416 from the first data domain to the second data domain by the RNN. To sequentially generate a plurality of sets of training mapped embeddings, the RNN may be run multiple times to generate the desired number of sets of mapped embeddings for LLM interpretation, for example by taking the output of the RNN at predetermined sample time steps. The chosen sample time steps may be determined in various ways such as experimentally or may be determined (e.g., chosen at the start of training) randomly. Note that as all sets of training mapped embeddings may be generated by the same RNN sequentially from the same set of training embeddings 416, dependencies can inherently exist between some or all sets of training mapped embeddings. The dependencies can provide a more structured representation of the training data 402 for interpretation by the pre-trained LLM 206.

In contrast to FIGS. 4A and 4B, the training mapped embeddings 412 can be provided to the pre-trained LLM 206 in a training input prompt (not shown). In particular, the training mapped embeddings 412 can be combined with a data extraction prompt 420 in the training input prompt. Similar to FIGS. 4A and 4B, the data extraction prompt 420 can comprise a first prompt corresponding to a system prompt and a second prompt corresponding to data extraction instructions. These prompts may be generated using the second LLM 208, in a manner similar to those described above with respect to FIG. 2. Specifically, the data extraction prompt 420 can comprise the training mapped embeddings 412 and can comprise instructions for the pre-trained LLM 206 to extract one or more data values from the training mapped embeddings 412. For example, where the training data 402 is a series of sequential transactions, the data extraction instructions can require the pre-trained LLM 206 to extract a monetary value of a particular transactions on a particular day, a highest amount of money spent/received or a date corresponding thereto, to determine the total amount of money spent across a period of time, etc. By requiring the pre-trained LLM 206 to extract or determine data values based on the training mapped embeddings 412, it is possible to evaluate whether the pre-trained LLM 206 can adequately interpret the training data (e.g., data representations) through the training mapped embeddings 412. Accordingly, the accuracy of the extracted data values can determine if the adapter 204 can generate suitable training mapped embeddings 412 that is interpretable by the pre-trained LLM 206. As described with respect to FIG. 2, the second prompt can also define rules for the data extraction, for example requiring the pre-trained LLM 206 to output the extracted values in a JSON file.

Ground-truth data values 428 may be provided to the pre-trained LLM 206 for training as training targets. The ground-truth data values 428 may correspond both to the training data 402 and the data extraction instructions outlined in the training input prompt 406. To generate the ground-truth data values 428, the training data representations comprising raw data can be used. For example, the pre-trained LLM 206 can process the training data 402 (e.g., raw data) with the data extraction instructions to generate (e.g., extract/determine) the ground-truth data values 428 without supervision. Note that the instruction to generate the ground-truth data values 428 can be substantially the same as those included in the training input prompt and may also be generated using the second LLM 208 in an analogous manner.

As depicted in FIG. 4C, the pre-trained LLM 206 can interpret or process the training input prompt to extract data values 422, which can be evaluated against the ground-truth data values 428. Specifically, the adapter 204 can be trained using token representation where the system as a whole can be trained to predict a series of extracted data values in the ground-truth data values 428, which may be represented as a sequence of tokens. The adapter 204 may be trained using a loss formulated as the negative log-likelihood (NLL) of each predicted token in the sequence of tokens corresponding to the ground-truth data values 428. The loss can be used to update the parameters (e.g., weights) of the adapter 204, for example, each of the jointly trained MLPs or the RNN, as the case may be. Analogous to FIG. 4B, the pre-trained LLM 206 is frozen during the entire training process (e.g., pre-training and fine-tuning) and as such is entirely unmodified throughout, even once the system is completely trained. Once fully trained, even without the data representations being represented in natural language (e.g., individual events in text/table format), the pre-trained LLM 206 can generate coherent and accurate narratives, for example, directly from the mapped embeddings 212 (e.g., vectors). Note that while the pre-trained LLM 206 did not generate narratives during this training process, requiring the pre-trained LLM 206 to extract data values from the training mapped embeddings 412 can nevertheless adequately evaluate the ability of the adapter 204 to generate embeddings that can be interpreted by the pre-trained LLM 206 and allow the pre-trained LLM 206 to generalize to narrative generation.

Further, it should be noted that the training of the adapter 204 as described with reference to FIGS. 4B and 4C may be used in combination. Additionally, while FIGS. 4B and 4C depict the pre-trained LLM 206 being used for generating the ground-truth data (e.g., ground-truth narratives 408 and ground-truth data values 428) and as part of the depicted system (e.g., used to generate the data values and narratives), the pre-trained LLM used for generating ground-truth data can be different from the pre-trained LLM used within the system itself.

FIGS. 5A and 5B depict methods for training the adapter 204 and respectively correspond to FIGS. 4B and 4C.

Referring to FIG. 5A, training data 402 comprising data representations is received or retrieved at 502. The data representations can comprise raw data such as sequential events. At 504, ground-truth narratives 408 can be generated by processing the training data 402 (e.g., raw data) with the pre-trained LLM 206, as described with respect to FIG. 4B. Narrative generation instructions in the form of a prompt can be provided with the training data 402 to the pre-trained LLM 206. At 506, the data processing module 202 can process the training data 402 to generate the training embeddings 416, as described with respect to FIG. 4B. The training embeddings 416 may correspond to a first data domain.

At 508, the adapter 204 generates the training adapted or mapped embeddings 412 from the training embeddings 416, as described with respect to FIG. 4B. The training mapped embeddings 412 can correspond to a second data domain recognized by the pre-trained LLM 206 where the adapter 204 is configured to perform the mapping from the first data domain (e.g., training embeddings 416) to the second data domain (e.g., training mapped embeddings 412). In particular, the training mapped embeddings 412 can comprise a plurality of sets of mapped embeddings, each of which can be a distinct transformation of the training embeddings 416 to the second data domain. In some embodiments, the adapter 204 comprises a plurality of independent MLPs, each configured to generate one of the plurality of sets of mapped embeddings, as described with respect to FIG. 4B. The MLPs can be jointly trained and can be initialized with distinct weights. In some embodiments, the adapter 204 comprises an RNN configured to sequentially generate the plurality of sets of mapped embeddings, as described with respect to FIG. 4B.

At 510, the training input prompt 406 comprising the training mapped embeddings 412 and the narrative generation instructions can be generated, as described with respect to FIG. 4B. The narrative generation instructions can correspond to those used in the generation of the ground-truth narratives 408. The training input prompt 406 can be processed at 512 by the pre-trained LLM 206 to generate the training narratives 410. At 514, the training narratives 410 can be evaluated against the ground-truth narratives 408 using a loss function, as described with respect to FIG. 4B. The parameters (e.g., weights) of the adapter 204 can be updated based on the loss function. For example, the weights of each MLP or the RNN can be updated based on the loss function. Note that the pre-trained LLM 206 is frozen during the training and fine-tuning process.

Referring to FIG. 5B, training data 402 comprising data representations is received or retrieved at 518. The data representations can comprise raw data such as sequential events. At 520, ground-truth data values 428 can be extracted by processing the training data 402 (e.g., raw data) with the pre-trained LLM 206, as described with respect to FIG. 4C. Data extraction instructions in the form of a prompt can be provided with the training data 402 to the pre-trained LLM 206. At 522, the data processing module 202 can process the training data 402 to generate the training embeddings 416, as described with respect to FIG. 4C. The training embeddings 416 may correspond to a first data domain.

At 524, the adapter 204 generates the training adapted or mapped embeddings 412 from the training embeddings 416, as described with respect to FIG. 4C. The training mapped embeddings 412 can correspond to a second data domain recognized by the pre-trained LLM 206 where the adapter 204 is configured to perform the mapping from the first data domain (e.g., training embeddings 416) to the second data domain (e.g., training mapped embeddings 412). In particular, the training mapped embeddings 412 can comprise a plurality of sets of mapped embeddings, each of which can be a distinct transformation of the training embeddings 416 to the second data domain. In some embodiments, the adapter 204 comprises a plurality of independent MLPs, each configured to generate one of the plurality of sets of mapped embeddings, as described with respect to FIG. 4C. The MLPs can be jointly trained and can be initialized with distinct weights. In some embodiments, the adapter 204 comprises an RNN configured to sequentially generate the plurality of sets of mapped embeddings, as described with respect to FIG. 4C.

At 526, the training input prompt 406 comprising the training mapped embeddings 412 and the data extraction instructions can be generated, as described with respect to FIG. 4C. The data extraction instructions can correspond to those used in the extraction of the ground-truth data values 428. The training input prompt 406 can be processed at 528 by the pre-trained LLM 206 to extract the training data values 422. At 530, the training data values 422 can be evaluated against the ground-truth data values 428 using a loss function, as described with respect to FIG. 4C. The parameters (e.g., weights) of the adapter 204 can be updated based on the loss function. For example, the weights of each MLP or the RNN can be updated based on the loss function. Note that the pre-trained LLM 206 is frozen during the training and fine-tuning process.

It should be noted that orders of operation outside of those depicted in FIGS. 5A and 5B are possible as well. For example, the generation of the ground-truth narratives 408 (at 504) and the extraction of ground-truth data values 428 (at 520) may be performed after the generation of the training narratives 410 (at 512) and the extraction of the training data values 422 (at 528). Similarly, the generation of the training embeddings 416 (at 506 and 522) can occur before the generation of the ground-truth narratives 408 (at 504) and the extraction of ground-truth data values 428 (at 520).

FIG. 6 depicts a flow chart showing an illustrative method for constructing an entity representation engine, according to an example embodiment. The entity representation engine can be a trained machine learning engine, for example, corresponding to the data processing module 202. The entity representation engine can receive raw input data associated with an entity, for example, data representations 120, and then generate a representation of that entity, for example, as the embeddings 210.

At 602, the method receives time series training data representing a plurality of discrete training event sequences, for example, corresponding to raw data representations 120. Each training event sequence is associated with a respective one of a plurality of discrete domains. The training event sequences are time-ordered sequences of sample interactions with the respective discrete domains. Thus, there are multiple training event sequences, and each training event sequence is associated with one of the discrete domains, so that multiple discrete domains are represented in the training event sequences.

At 604, the method applies representation learning to the time series training data received at 602 to generate a trained representation engine. Some non-limiting illustrative examples of application of representation learning to time series training data are described further below.

The trained representation engine generated at 604 is adapted to ingest entity time series data and, from the entity time series data, generate a corresponding single unified entity representation characterizing a distribution of the entity interactions with the distinct discrete domains. The entity time series data that the trained representation engine will ingest represents a plurality of discrete entity event sequences for a particular entity. Each entity event sequence is associated with a respective one of the distinct domains, and the entity event sequences are time-ordered sequences of entity interactions for that entity with the respective distinct domains. Thus, even though there are entity event sequences associated with a plurality of different distinct domains, the output of the trained representation engine generated at 604 is not multiple representations, but rather a single unified entity representation. The unified entity representation may be a reduced dimensionality characterization, for example, and without limitation, a feature vector, or weights of a neural network.

That is, the data processing module 202 (e.g., the trained representation engine) can generate the single unified entity representation corresponding to the embeddings 210 from data representations 120 corresponding to a series of raw data belonging to a plurality of domains (e.g., time-series data). For example, for time series data being a plurality of sequential financial events of various types such as credit card transactions, checking account purchases, wire transfers, bill payments, payroll deposits, etc., each corresponding to a different domain, the embeddings 210, generated as vectors, represent a single unified entity representation for the plurality of sequential financial events.

In some embodiments, the trained representation engine may be adapted to generate the single unified entity representation by combining a plurality of domain-specific entity representations into the single unified entity representation, for example by concatenation or aggregation, including summing and averaging.

At 606, which may be optional, the method uses labeled unified entity representation instances to train a downstream prediction model to predict an entity characteristic, for example corresponding to the embeddings 210, from an unlabeled unified entity representation instance. The labeled unified entity representation instances may be obtained by using the trained representation engine from 604 to obtain unified entity representation instances, and then applying a target label for the entity characteristic to be predicted. The entity characteristic to be predicted may be a characteristic of the entity in interacting with one of the distinct separate domains, or an aggregate statistic of the entity interactions, or another characteristic.

Some illustrative, non-limiting examples of entity characteristics are now provided. Where the entity is a hospital, the entity characteristic may be when the next patient is expected to arrive by ambulance, or the total number of patients expected in the next hour, or the gender distribution of the patients expected within the next six hours. As another example, where the entity is an individual and the data domains relate to financial transactions, the entity characteristic may be the timing and/or amount of the next credit card payment, or a total amount of deposits expected within the individual's checking account within the next month, or the individual's credit capacity. Or, where the entity is a monitored wildlife refuge, the entity characteristic may be what type of avian is expected to arrive next, or the total number of avians expected to be present in the wildlife refuge at some future time. Where the entity is a taxicab or a rideshare vehicle, the prediction may be, for example, the time of the next trip, or the distance of the next trip, or the time of the next delivery trip. Each of the foregoing is merely a non-limiting, illustrative example.

The downstream prediction model trained at 606 may be trained using any suitable machine learning technology and, unlike at 604, the prediction model trained at 606 is not limited to representation learning. For example, in one embodiment, 606 can be implemented using a MLP, which consists of fully connected layers and non-linear layers and takes the unified entity representation as input, and directly outputs the predictions for the downstream tasks. In another embodiment, a linear transformation may be directly applied to the unified entity representation to obtain the prediction.

Some non-limiting, illustrative implementations of 604 can comprise model-specific self-supervised learning, model-agnostic self-supervised learning, and supervised learning. For example, model-specific self-supervised learning can comprise: RNN-based self-supervised learning, meta-TPP-based self-supervised learning, conditional diffusion model for representation learning, BERT-style generative modelling, and causal attention for transformers. As another example, model-agnostic self-supervised learning can comprise: prediction of aggregated daily interactions, contrastive learning, alignment encoding, masked auto-encoding, and aggregated statistics prediction within different time windows.

### Experimental Results

Example embodiments of the system of FIGS. 1 and 2 were evaluated. The LLM 206 was implemented as a Llama™ 3.2-3B model. The adapter 204 was implemented as a plurality of MLPs where each MLP is configured to generate a single token (a set of mapped embeddings 212). Low-Rank Adaptation (LoRA) with a matrix rank of 8 was used for fine-tuning, targeting the query (q) and value (v) projection matrices in the attention mechanism. The MLPs were trained for 10,000 gradient updates with a batch size of 30. As used below, single-token adapter refers to adapters that generate a single set of mapped embeddings (e.g., ELM adapter), while multi-token adapter refers to adapters that generate a plurality of sets of mapped embeddings (e.g., example embodiment).

Table 2 below shows the impact of fine-tuning the LLM in the ELM framework. As shown in Table 2, there is a significant performance gap between updating and freezing the LLM during fine-tuning, highlighting the importance of fine-tuning the LLM to achieve optimal performance.

TABLE 2
Performance Effects of LLM Fine-Tuning

| Model | Valid Loss (NLL) | Train Loss (NLL) |
|---|---|---|
| Single-Token Adapter + | 0.9774 | 0.9209 |
| Frozen LLM | | |
| Single-Token Adapter + | 0.5229 | 0.4707 |
| Fine-tuned LLM | | |

Table 3 below shows the impact of generating multiple sets of mapped embeddings using the adapter. As shown in Table 3, when the number of sets of embeddings is fixed to 1 (e.g., using a single MLP as the adapter), the performance of the example embodiment aligns with an ELM using a frozen LLM. FIG. 7A depicts the training curves of various example embodiments where different numbers of sets of mapped embeddings are generated. 702, 706, and 710 respectively correspond to training curves of example embodiments where 1, 2, and 6 sets of mapped embeddings are generated. 704, 708, and 712 respectively correspond to validation curves of example embodiments where 1, 2, and 6 sets of mapped embeddings are generated. FIG. 7A and Table 3 show a sharp performance increase when generating two sets of mapped embeddings, with further improvements observed as the number of sets of embeddings increases. These results suggest that multiple embeddings enable the LLM to capture diverse perspectives within complex representations, making it more compatible with pre-trained LLMs. In particular, increasing the sets of embeddings generated can improve the performance of the example embodiment. For these experiments, the LLM is frozen during fine-tuning.

TABLE 3
Performance Effects of Multiple Sets of Mapped Embeddings

| Sets of Embeddings | Valid Loss (NLL) | Train Loss (NLL) |
|---|---|---|
| 1 | 0.9774 | 0.9209 |
| 2 | 0.8514 | 0.7789 |
| 3 | 0.8077 | 0.7113 |
| 4 | 0.7794 | 0.6799 |
| 5 | 0.7494 | 0.6327 |
| 6 | 0.7281 | 0.6104 |

Table 4 below shows the impact of generating multiple sets of mapped embeddings using the adapter and fine-tuning the LLM. FIG. 7B depicts the training curves of various example embodiments where different numbers of sets of mapped embeddings are generated and where the LLM is fine-tuned. 720, 724, 728, and 732 respectively correspond to training curves of example embodiments where 1, 2, 3 and 6 sets of mapped embeddings are generated. 722, 726, 730, and 734 respectively correspond to validation curves of example embodiments where 1, 2, 3, and 6 sets of mapped embeddings are generated. As shown in Table 4 and FIG. 7B, when both the adapter and LLM are fine-tuned (e.g., corresponding to the ELM framework), increasing the sets of embeddings generated using the multi-token adapter does not significantly affect performance. This can indicate that the fine-tuning of the LLM inherently adapts it to handle complex embeddings, potentially at the cost of its original language capabilities.

TABLE 4
Performance Effects of Multiple Sets of
Mapped Embeddings when LLM is Fine-Tuned

| Sets of Embeddings | Valid Loss (NLL) | Train Loss (NLL) |
|---|---|---|
| 1 | 0.5229 | 0.4707 |
| 2 | 0.5217 | 0.4734 |
| 3 | 0.5235 | 0.4718 |
| 4 | 0.5229 | 0.4738 |
| 5 | 0.522 | 0.4743 |
| 6 | 0.5242 | 0.4771 |

FIG. 7C depicts the training curves of a standard ELM framework against various example embodiments where different numbers of sets of mapped embeddings are generated. Note that the LLM is frozen during fine-tuning for the example embodiments depicted in FIG. 7C. 744, 748, and 752 respectively correspond to training curves of example embodiments where 1, 2, and 6 sets of mapped embeddings are generated. 746, 750, and 754 respectively correspond to validation curves of example embodiments where 1, 2, and 6 sets of mapped embeddings are generated. 740 and 742 respectively correspond to training and validation curves of the standard ELM framework.

As depicted in FIG. 7C, while the example embodiment may not match ELM's performance at 6 sets of mapped embeddings, the performance gap is narrowed significantly. This can demonstrate that freezing the LLM can offer two advantages: (1) preservation of language capabilities by the LLM where degradation observed in fine-tuned LLMs can be avoided; and (2) cost-effective deployment by eliminating the need for additional model validation and reducing the parameter overhead, as only adapter weights need to be shared (compared to ELM's requirement of sharing the entire LLM, which can range from 8 B to 405 B parameters).

The above experimental results can demonstrate the effectiveness of the disclosed systems and methods in balancing performance and efficiency.

It would be appreciated by one of ordinary skill in the art that the system and components shown in the figures may include components not shown in the drawings. For simplicity and clarity of the illustration, elements in the figures are not necessarily to scale and are only schematic. It will be apparent to persons skilled in the art that a number of variations and modifications can be made without departing from the scope of the invention as described herein.

It is contemplated that any part of any aspect or embodiment discussed in this specification can be implemented or combined with any part of any other aspect or embodiment discussed in this specification, so long as such parts are not mutually exclusive with each other.

It should be recognized that features and aspects of the various examples provided above can be combined into further examples that also fall within the scope of the present disclosure.

When used in this specification and claims, the terms “comprises” and “comprising” and variations thereof mean that the specified features, steps or integers are included. The terms are not to be interpreted to exclude the presence of other features, steps or components. Additionally, the term “connect” and variants of it such as “connected,” “connects,” and “connecting” as used in this description are intended to include indirect and direct connections unless otherwise indicated. For example, if a first device is connected to a second device, that coupling may be through a direct connection or through an indirect connection via other devices and connections. Similarly, if the first device is communicatively connected to the second device, communication may be through a direct connection or through an indirect connection via other devices and connections. Further, the singular forms “a,” “an,” and “the” are intended to include the plural forms as well, unless the context clearly indicates otherwise.

The embodiments have been described above with reference to flow, sequence, and block diagrams of methods, apparatuses, systems, and computer program products. In this regard, the depicted flow, sequence, and block diagrams illustrate the architecture, functionality, and operation of implementations of various embodiments. For instance, each block of the flow and block diagrams and operation in the sequence diagrams may represent a module, segment, or portion of code, which comprises one or more executable instructions for implementing the specified action(s). In some alternative embodiments, the action(s) noted in that block or operation may occur out of the order noted in those figures. For example, two blocks or operations shown in succession may, in some embodiments, be executed substantially concurrently, or the blocks or operations may sometimes be executed in the reverse order, depending upon the functionality involved. Some specific examples of the foregoing have been noted above but those noted examples are not necessarily the only examples. Each block of the flow and block diagrams and operation of the sequence diagrams, and combinations of those blocks and operations, may be implemented by special purpose hardware-based systems that perform the specified functions or acts, or combinations of special purpose hardware and computer instructions.

Use of language such as “at least one of X, Y, and Z,” “at least one of X, Y, or Z,” “at least one or more of X, Y, and Z,” “at least one or more of X, Y, and/or Z,” or “at least one of X, Y, and/or Z,” is intended to be inclusive of both a single item (e.g., just X, or just Y, or just Z) and multiple items (e.g., {X and Y}, {X and Z}, {Y and Z}, or {X, Y, and Z}). The phrase “at least one of” and similar phrases are not intended to convey a requirement that each possible item must be present, although each possible item may be present.

The invention may also broadly consist in the parts, elements, steps, examples and/or features referred to or indicated in the specification individually or collectively in any and all combinations of two or more said parts, elements, steps, examples and/or features. In particular, one or more features in any of the embodiments described herein may be combined with one or more features from any other embodiment(s) described herein.

1. A narrative generation method, comprising:
receiving a first set of data representations of a first data domain;
generating a plurality of second sets of data representations of a second data domain from the first set of data representations using an adapter; and
generating one or more narratives from the plurality of second sets of data representations by interpreting the plurality of second sets of data representations using a large language model (LLM).

2. The method of claim 1,
wherein the first set of data representations comprises vector embeddings in the first data domain and the plurality of second sets of data representations comprises vector embeddings in the second data domain;
wherein the vector embeddings in the first data domain correspond to a first vector dimension and the vector embeddings in the second data domain correspond to a second vector dimension different from the first vector dimension;
wherein the adapter has been trained to map vectors from the first vector dimension to the second vector dimension; and
wherein the vector embeddings in the second data domain comprise language token embeddings.

3. The method of claim 1,
wherein the adapter comprises a plurality of independent multi-layer perceptrons (MLPs);
wherein each of the plurality of MLPs is configured to generate one of the plurality of second sets of data representations; and
wherein each of the plurality of second sets of data representations comprises a second set of data representations corresponding to an independent transformation of the first set of data representations by a respective MLP of the plurality of MLPs.

4. The method of claim 3, wherein the plurality of independent MLPs are respectively initialized with different weights during training.

5. The method of claim 1,
wherein the adapter comprises a recurrent neural network (RNN);
wherein each of the plurality of second sets of data representations comprises a second set of data representations corresponding to an independent transformation of the first set of data representations sequentially generated by the RNN.

6. The method of claim 1, wherein the first set of data representations comprises sequential events.

7. The method of claim 6, wherein the first set of data representations are generated by characterizing the sequential events using a neural network.

8. The method of claim 1, wherein generating the one or more narratives using the LLM comprises:
generating an input prompt for interpreting the plurality of second sets of data representations, the input prompt comprising the plurality of second sets of data representations; and
processing the input prompt with the LLM.

9. The method of claim 8, wherein the input prompt comprises:
a first prompt for providing the LLM with background, context, or role for interpreting the plurality of second sets of data representations; and
a second prompt defining the one or more narratives to be generated by the LLM;
wherein the input prompt is generated according to a prompt template comprising placeholders for the plurality of second sets of data representations; and
wherein the input prompt defines one or more rules for the one or more narratives.

10. The method of claim 1, wherein the adapter has been trained by:
generating ground truth narratives from training sequential events using the LLM for evaluation against the one or more narratives generated using the LLM by interpreting the plurality of second sets of data representations.

11. The method of claim 10,
wherein each of the ground truth narratives comprises a sequence of tokens;
wherein the adapter has been trained by having the LLM generate tokens of the sequence of tokens in sequential order; and
wherein the adapter has been trained using a loss function comprising negative log-likelihood of the tokens.

12. The method of claim 1, wherein the adapter has been trained by:
identifying one or more ground truth data values from training sequential events for evaluation against one or more data values extracted from the plurality of second sets of data representations using the LLM.

13. The method of claim 1, wherein the adapter comprises a plurality of jointly trained machine learning models.

14. The method of claim 1,
wherein the LLM is a pre-trained LLM; and
wherein the LLM was frozen during training of the adapter.

15. The method of claim 1,
wherein the first set of data representations comprises financial transactions; and
wherein the one or more narratives comprise: a financial recommendation based on the financial transactions, a description of the financial transactions, an analysis of the financial transactions, or combinations thereof.

16. A method of training an adapter for use in narrative generation, comprising:
generating ground truth narratives from a plurality of sequential events using a pre-trained large language model (LLM);
training the adapter to generate a plurality of second sets of data representations of a second data domain from a first set of data representations of a first data domain for interpretation by the pre-trained LLM by:
generating a plurality of second sets of training data representations for each of a plurality of first sets of training data representations corresponding to the plurality of sequential events;
generating a plurality of training narratives by interpreting the plurality of second sets of training data representations using the pre-trained LLM; and
updating weights of the adapter based on a comparison of the plurality of training narratives against the ground truth narratives,
wherein the pre-trained LLM is frozen.

17. A method of training an adapter for use in narrative generation, comprising:
identifying ground truth data values from a plurality of sequential events using a pre-trained large language model (LLM);
training the adapter to generate a plurality of second sets of data representations of a second data domain from a first set of data representations of a first data domain for interpretation by the pre-trained LLM by:
generating a plurality of second sets of training data representations for each of a plurality of first sets of training data representations corresponding to the plurality of sequential events;
extracting a plurality of training data values by interpreting the plurality of second sets of training data representations using the pre-trained LLM; and
updating weights of the adapter based on a comparison of the plurality of training data values against the ground truth values,
wherein the pre-trained LLM is frozen.

18. The method of claim 16,
wherein the adapter comprises a plurality of independent multi-layer perceptrons (MLPs); and
wherein the training of the adapter further comprises:
initializing each of the plurality of independent MLPs with a distinct set of weights.

19. A system comprising at least one processing unit configured to perform a narrative generation method, comprising:
receiving a first set of data representations of a first data domain;
generating a plurality of second sets of data representations of a second data domain from the first set of data representations using an adapter; and
generating one or more narratives from the plurality of second sets of data representations by interpreting the plurality of second sets of data representations using a large language model (LLM).

20. At least one non-transitory computer readable medium having stored thereon computer instructions, which, when executed by at least one processor, causes the at least one processor to perform a narrative generation method, comprising:
receiving a first set of data representations of a first data domain;
generating a plurality of second sets of data representations of a second data domain from the first set of data representations using an adapter; and
generating one or more narratives from the plurality of second sets of data representations by interpreting the plurality of second sets of data representations using a large language model (LLM).
